(19) United States
(12) Patent Application Publication
(10) Pub. No.: US 2024/0098703 A1
(43) Pub. Date: Mar. 21, 2024

(54) BEAM MANAGEMENT BLOCK FOR SIDELINK

(71) Applicant: QUALCOMM Incorporated, San Diego, CA (US)

(72) Inventors: Qing LI, Princeton Junction, NJ (US); Sourjya DUTTA, San Diego, CA (US); Kapil GULATI, Belle Mead, NJ (US); Junyi LI, Fairless Hills, PA (US)

(21) Appl. No.: 18/458,980

(22) Filed: Aug. 30, 2023

Related U.S. Application Data
(60) Provisional application No. 63/375,903, filed on Sep. 16, 2022.

(51) Int. Cl. H04W 72/02; H04W 16/28; H04W 72/25

(52) U.S. Cl. CPC H04W 72/02; H04W 16/28; H04W 72/25

(57) ABSTRACT

Various aspects of the present disclosure generally relate to wireless communication. In some aspects, a user equipment (UE) may perform sensing in a sidelink resource pool. The UE may select, based at least in part on the sensing, one or more sidelink resources for one or more sidelink beam management blocks, where each sidelink beam management block includes at least one reference signal and sidelink control information. The UE may transmit the one or more sidelink beam management blocks in a sidelink beam management block burst using the one or more sidelink resources. Numerous other aspects are described.

### CROSS-REFERENCE TO RELATED APPLICATION

This Patent Application claims priority to U.S. Provisional Patent Application No. 63/375,903, filed on Sep. 16, 2022, entitled “REFERENCE SIGNAL BLOCK FOR SIDELINK,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for beam management blocks for sidelink.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus of a user equipment (UE) for wireless communication. The apparatus may include one or more memories and one or more processors coupled to the one or more memories. The one or more processors may be configured to perform sensing in a sidelink resource pool. The one or more processors may be configured to select, based at least in part on the sensing, one or more sidelink resources for one or more sidelink beam management blocks, where each sidelink beam management block includes at least one beam management signal and sidelink control information (SCI). The one or more processors may be configured to transmit the one or more sidelink beam management blocks in a sidelink beam management block burst using the one or more sidelink resources.

Some aspects described herein relate to an apparatus of a UE for wireless communication. The apparatus may include one or more memories and one or more processors coupled to the one or more memories. The one or more processors may be configured to monitor for one or more sidelink beam management blocks in a sidelink beam management block burst in a sidelink resource pool. The one or more processors may be configured to receive the one or more sidelink beam management blocks in the sidelink beam management block burst, where each sidelink beam management block in the sidelink beam management block burst includes at least one beam management signal and SCI. The one or more processors may be configured to select a beam based at least in part on the one or more sidelink beam management blocks in the sidelink beam management block burst.

Some aspects described herein relate to a method of wireless communication performed by a UE. The method may include performing sensing in a sidelink resource pool. The method may include selecting, based at least in part on the sensing, one or more sidelink resources for one or more sidelink beam management blocks, where each sidelink beam management block includes at least one beam management signal and SCI. The method may include transmitting the one or more sidelink beam management blocks in a sidelink beam management block burst using the one or more sidelink resources.

Some aspects described herein relate to a method of wireless communication performed by a UE. The method may include monitoring for one or more sidelink beam management blocks in a sidelink beam management block burst in a sidelink resource pool. The method may include receiving the one or more sidelink beam management blocks in the sidelink beam management block burst, where each sidelink beam management block in the sidelink beam management block burst includes at least one beam management signal and SCI. The method may include selecting a beam based at least in part on the one or more sidelink beam management blocks in the sidelink beam management block burst.

Some aspects described herein relate to a non-transitory computer-readable medium that stores a set of instructions for wireless communication by a UE. The set of instructions, when executed by one or more processors of the UE, may cause the UE to perform sensing in a sidelink resource pool. The set of instructions, when executed by one or more processors of the UE, may cause the UE to select, based at least in part on the sensing, one or more sidelink resources for one or more sidelink beam management blocks, where each sidelink beam management block includes at least one beam management signal and SCI. The set of instructions, when executed by one or more processors of the UE, may cause the UE to transmit the one or more sidelink beam management blocks in a sidelink beam management block burst using the one or more sidelink resources.

Some aspects described herein relate to a non-transitory computer-readable medium that stores a set of instructions for wireless communication by a UE. The set of instructions, when executed by one or more processors of the UE, may cause the UE to monitor for one or more sidelink beam management blocks in a sidelink beam management block burst in a sidelink resource pool. The set of instructions, when executed by one or more processors of the UE, may cause the UE to receive the one or more sidelink beam management blocks in the sidelink beam management block burst, where each sidelink beam management block in the sidelink beam management block burst includes at least one beam management signal and SCI. The set of instructions, when executed by one or more processors of the UE, may cause the UE to select a beam based at least in part on the one or more sidelink beam management blocks in the sidelink beam management block burst.

Some aspects described herein relate to an apparatus for wireless communication. The apparatus may include means for performing sensing in a sidelink resource pool. The apparatus may include means for selecting, based at least in part on the sensing, one or more sidelink resources for one or more sidelink beam management blocks, where each sidelink beam management block includes at least one beam management signal and SCI. The apparatus may include means for transmitting the one or more sidelink beam management blocks in a sidelink beam management block burst using the one or more sidelink resources.

Some aspects described herein relate to an apparatus for wireless communication. The apparatus may include means for monitoring for one or more sidelink beam management blocks in a sidelink beam management block burst in a sidelink resource pool. The apparatus may include means for receiving the one or more sidelink beam management blocks in the sidelink beam management block burst, where each sidelink beam management block in the sidelink beam management block burst includes at least one beam management signal and SCI. The apparatus may include means for selecting a beam based at least in part on the one or more sidelink beam management blocks in the sidelink beam management block burst.

Some aspects described herein relate to a method of wireless communication performed by an apparatus of a UE. The method may include monitoring for one or more sidelink beam management blocks (e.g., reference signal blocks (S-RSBs)) in an S-RSB burst in a sidelink resource pool. The method may include receiving the one or more S-RSBs in the S-RSB burst, where each S-RSB in the S-RSB burst includes at least one reference signal (RS) and SCI. The method may include selecting a beam based at least in part on the one or more S-RSBs in the S-RSB burst.

Some aspects described herein relate to a method of wireless communication performed by an apparatus of a UE. The method may include performing sensing in a sidelink resource pool. The method may include selecting, based at least in part on the sensing, one or more sidelink resources for one or more S-RSBs, where each S-RSB includes at least one RS and SCI. The method may include transmitting the one or more S-RSBs in an S-RSB burst using the one or more sidelink resources.

Some aspects described herein relate to an apparatus of a UE for wireless communication. The apparatus may include a memory and one or more processors coupled to the memory. The one or more processors may be configured to perform sensing in a sidelink resource pool. The one or more processors may be configured to select, based at least in part on the sensing, one or more sidelink resources for one or more S-RSBs, where each S-RSB includes at least one RS and SCI. The one or more processors may be configured to transmit the one or more S-RSBs in an S-RSB burst using the one or more sidelink resources.

Some aspects described herein relate to an apparatus of a UE for wireless communication. The apparatus may include a memory and one or more processors coupled to the memory. The one or more processors may be configured to monitor for one or more S-RSBs in an S-RSB burst in a sidelink resource pool. The one or more processors may be configured to receive the one or more S-RSBs in the S-RSB burst, where each S-RSB in the S-RSB burst includes at least one RS and SCI. The one or more processors may be configured to select a beam based at least in part on the one or more S-RSBs in the S-RSB burst.

Some aspects described herein relate to a non-transitory computer-readable medium that stores a set of instructions for wireless communication by a UE. The set of instructions, when executed by one or more processors of the UE, may cause the UE to perform sensing in a sidelink resource pool. The set of instructions, when executed by one or more processors of the UE, may cause the UE to select, based at least in part on the sensing, one or more sidelink resources for one or more S-RSBs, where each S-RSB includes at least one RS and SCI. The set of instructions, when executed by one or more processors of the UE, may cause the UE to transmit the one or more S-RSBs in an S-RSB burst using the one or more sidelink resources.

Some aspects described herein relate to a non-transitory computer-readable medium that stores a set of instructions for wireless communication by a UE. The set of instructions, when executed by one or more processors of the UE, may cause the UE to monitor for one or more S-RSBs in an S-RSB burst in a sidelink resource pool. The set of instructions, when executed by one or more processors of the UE, may cause the UE to receive the one or more S-RSBs in the S-RSB burst, where each S-RSB in the S-RSB burst includes at least one RS and SCI. The set of instructions, when executed by one or more processors of the UE, may cause the UE to select a beam based at least in part on the one or more S-RSBs in the S-RSB burst.

Some aspects described herein relate to an apparatus for wireless communication. The apparatus may include means for performing sensing in a sidelink resource pool. The apparatus may include means for selecting, based at least in part on the sensing, one or more sidelink resources for one or more S-RSBs, where each S-RSB includes at least one RS and SCI. The apparatus may include means for transmitting the one or more S-RSBs in an S-RSB burst using the one or more sidelink resources.

Some aspects described herein relate to an apparatus for wireless communication. The apparatus may include means for monitoring for one or more S-RSBs in an S-RSB burst in a sidelink resource pool. The apparatus may include means for receiving the one or more S-RSBs in the S-RSB burst, where each S-RSB in the S-RSB burst includes at least one RS and SCI. The apparatus may include means for selecting a beam based at least in part on the one or more S-RSBs in the S-RSB burst.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating examples of channel state information reference signal beam management procedures, in accordance with the present disclosure.

FIG. 6 is a diagram illustrating examples of sidelink messaging, in accordance with the present disclosure.

FIG. 7 is a diagram illustrating an example associated with sensing and transmitting sidelink reference signal blocks (S-RSBs), in accordance with the present disclosure.

FIG. 8 is a diagram illustrating an example of a beam sweeping pattern for beamforming, in accordance with the present disclosure.

FIG. 9 is a diagram illustrating an example of a beam sweeping pattern for beam fine tuning, in accordance with the present disclosure.

FIG. 10 is a diagram illustrating an example of a beam sweeping pattern for beam fine tuning, in accordance with the present disclosure.

FIG. 11 is a diagram illustrating an example of beam sweeping patterns, in accordance with the present disclosure.

FIG. 12 is a diagram illustrating an example of a resource pool for S-RSB, in accordance with the present disclosure.

FIG. 13 is a diagram illustrating an example of resources associated with beams, in accordance with the present disclosure.

FIGS. 14A and 14B are diagrams illustrating an example of S-RSB beam sweeping, in accordance with the present disclosure.

FIGS. 15A and 15B are diagrams illustrating an example of S-RSB beam sweeping for beam fine tuning, in accordance with the present disclosure.

FIG. 16 is a diagram illustrating an example process performed, for example, by a UE or an apparatus of a UE, in accordance with the present disclosure.

FIG. 17 is a diagram illustrating an example process performed, for example, by a UE or an apparatus of a UE, in accordance with the present disclosure.

FIG. 18 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

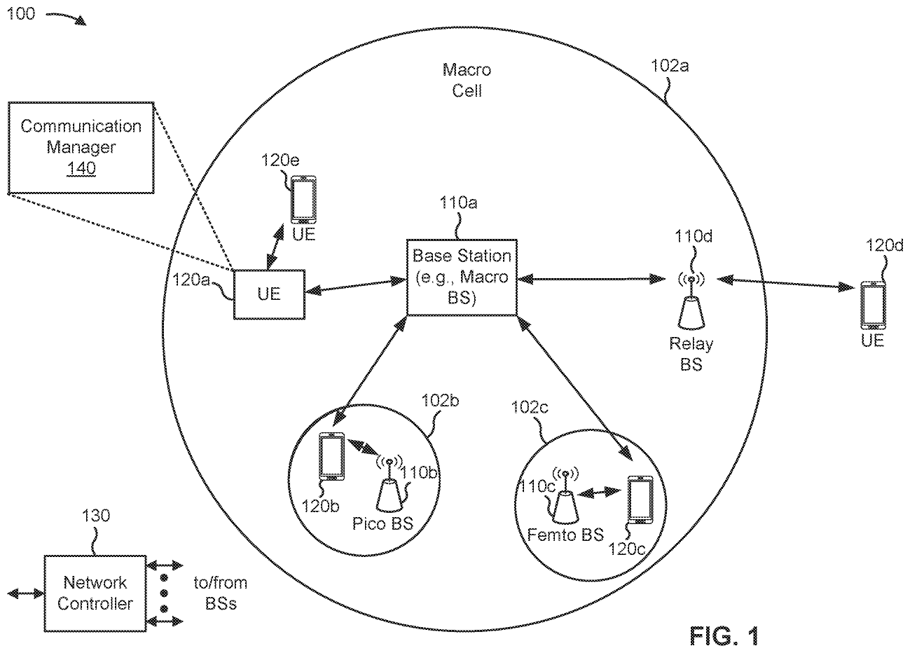

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmit receive point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120) may include a communication manager 140. As described in more detail elsewhere herein, the communication manager 140 may perform sensing in a sidelink resource pool. The communication manager 140 may select, based at least in part on the sensing, one or more sidelink resources for one or more sidelink beam management blocks (e.g., reference signal blocks (S-RSBs)), where each sidelink beam management block includes at least one beam management signal and sidelink control information (SCI). The communication manager 140 may transmit the one or more sidelink beam management blocks in a sidelink beam management block burst using the one or more sidelink resources. Additionally, or alternatively, the communication manager 140 may perform one or more other operations described herein.

In some aspects, a second UE (e.g., UE 120) may include a communication manager 140. As described in more detail elsewhere herein, the communication manager 140 may monitor for one or more sidelink beam management blocks in a sidelink beam management block burst in a sidelink resource pool. The communication manager may receive the one or more sidelink beam management blocks in the sidelink beam management block burst, where each sidelink beam management block in the sidelink beam management block burst includes at least one beam management signal and SCI. The communication manager 140 may select a beam based at least in part on the one or more sidelink beam management blocks in the sidelink beam management block burst. Additionally, or alternatively, the communication manager 140 may perform one or more other operations described herein.

As indicated above, FIG. 1 is provided as an example. Other examples may differ from what is described with regard to FIG. 1.

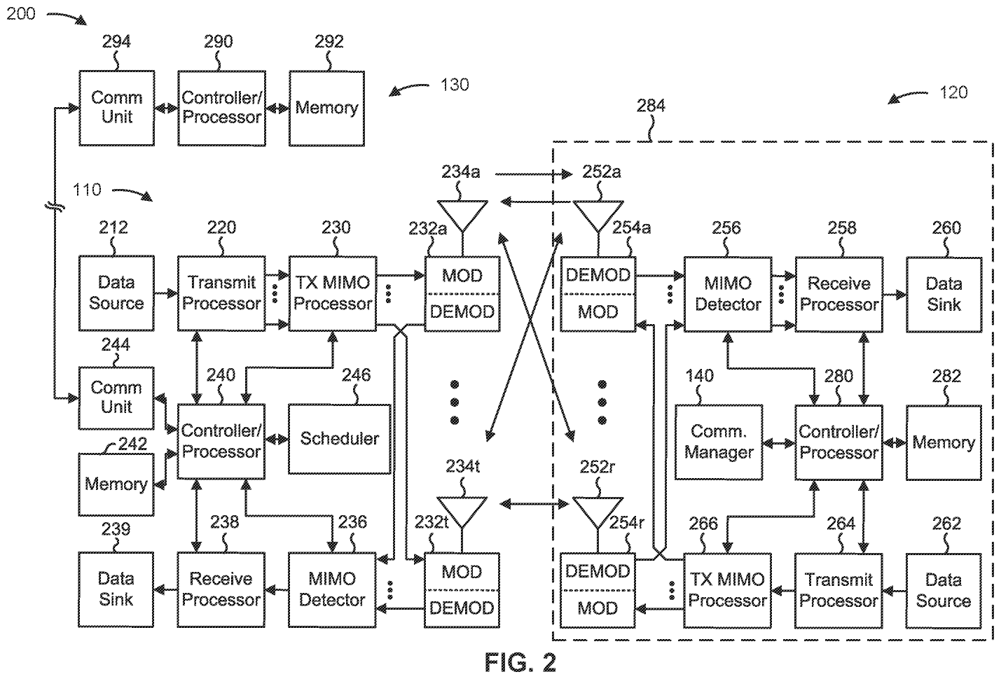

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

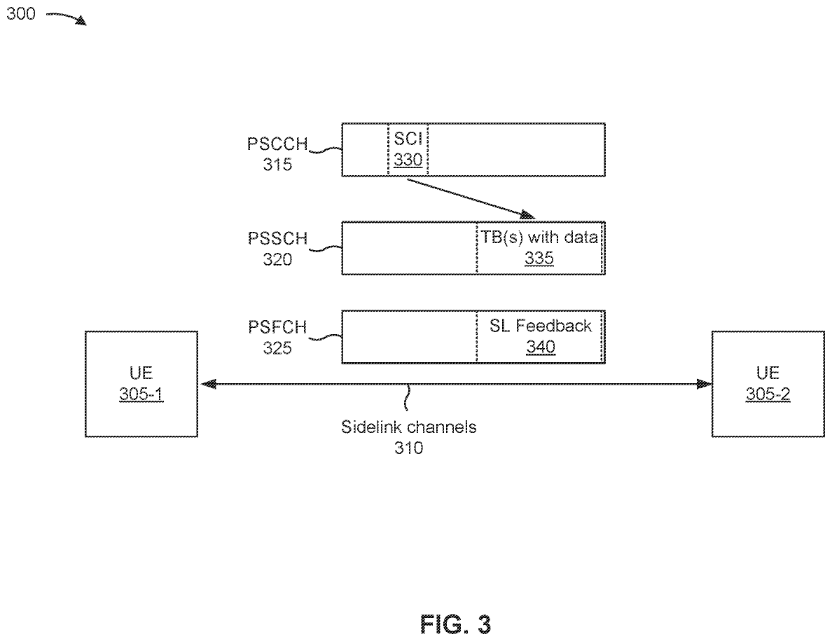

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-18).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-18).

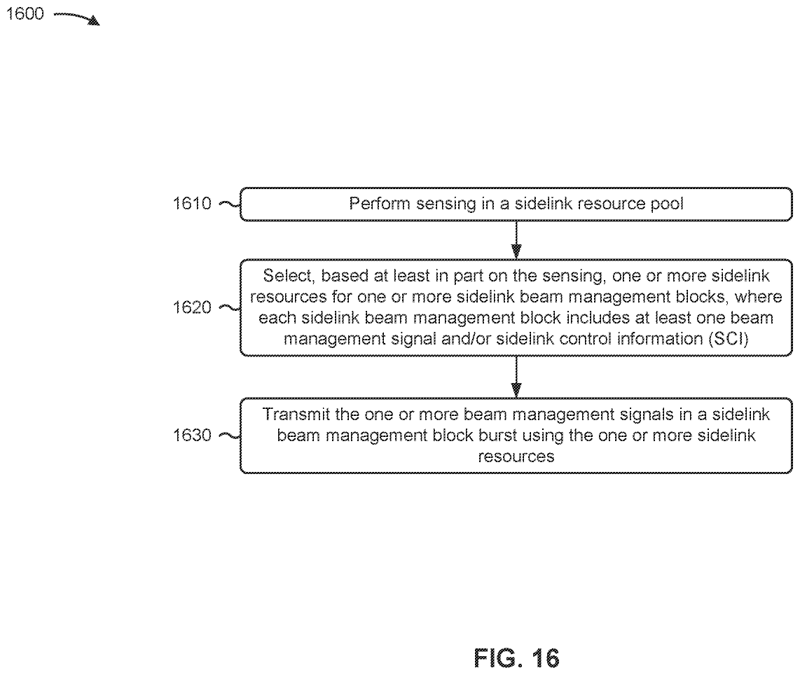

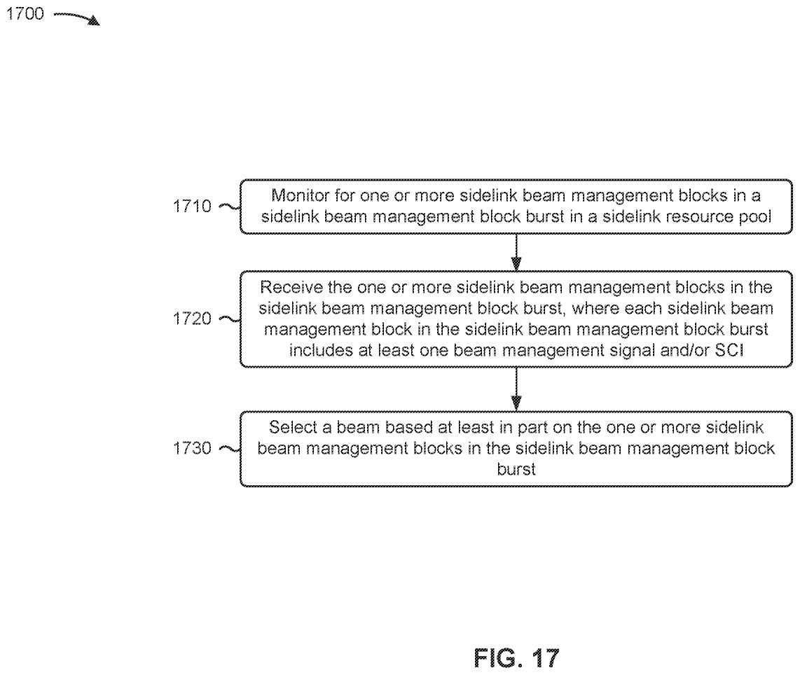

The controller/processor 240 of the network node 110, the controller/processor 280 of the UE 120, and/or any other component(s) of FIG. 2 may perform one or more techniques associated with beam sweeping S-RSBs, as described in more detail elsewhere herein. For example, the controller/processor 240 of the network node 110, the controller/processor 280 of the UE 120, and/or any other component(s) of FIG. 2 may perform or direct operations of, for example, process 1600 of FIG. 16, process 1700 of FIG. 17, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1600 of FIG. 16, process 1700 of FIG. 17, and/or other processes as described herein. In some examples, executing instructions may include running the instructions, converting the instructions, compiling the instructions, and/or interpreting the instructions, among other examples.

In some aspects, the UE 120 includes means for performing sensing in a sidelink resource pool; means for selecting, based at least in part on the sensing, one or more sidelink resources for one or more sidelink beam management blocks, where each sidelink beam management block includes at least one beam management signal and SCI; and/or means for transmitting the one or more sidelink beam management blocks in a sidelink beam management block burst using the one or more sidelink resources. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for monitoring for one or more sidelink beam management blocks in a sidelink beam management block burst in a sidelink resource pool; means for receiving the one or more sidelink beam management blocks in the sidelink beam management block burst, where each sidelink beam management block in the sidelink beam management block burst includes at least one beam management signal and SCI; and/or means for selecting a beam based at least in part on the one or more sidelink beam management blocks in the sidelink beam management block burst.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. A memory in FIG. 2 may include one or more memories. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry SCI 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink resource allocation mode (e.g., Mode 1) where resource selection and/or scheduling is performed by a network node 110 (e.g., a base station, a CU, or a DU). For example, the UE 305 may receive a grant (e.g., in downlink control information (DCI) or in a radio resource control (RRC) message, such as for configured grants) from the network node 110 (e.g., directly or via one or more network nodes) for sidelink channel access and/or scheduling. In some aspects, a UE 305 may operate using a resource allocation mode (e.g., Mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the resource allocation mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

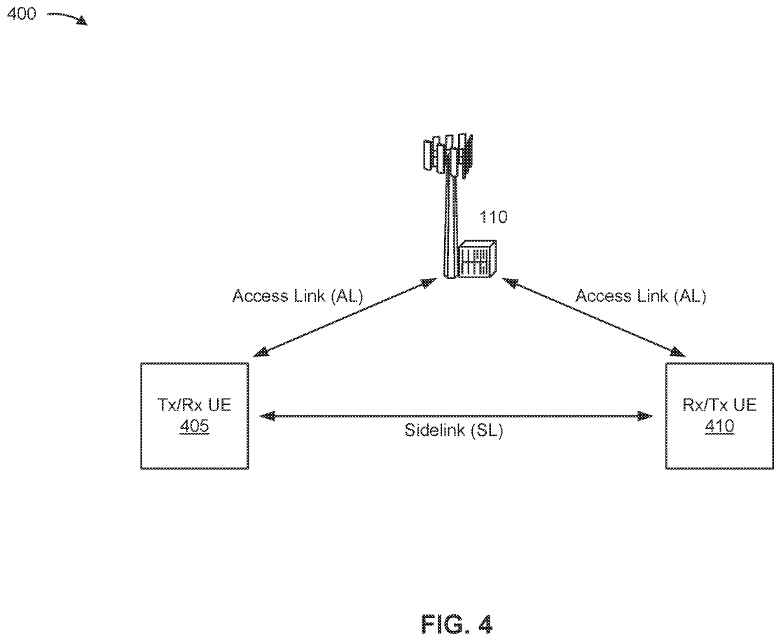

FIG. 4 is a diagram illustrating an example 400 of sidelink communications and access link communications, in accordance with the present disclosure.

As shown in FIG. 4, a Tx/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 (e.g., directly or via one or more network nodes), such as via a first access link. Additionally, or alternatively, in some sidelink resource allocation modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

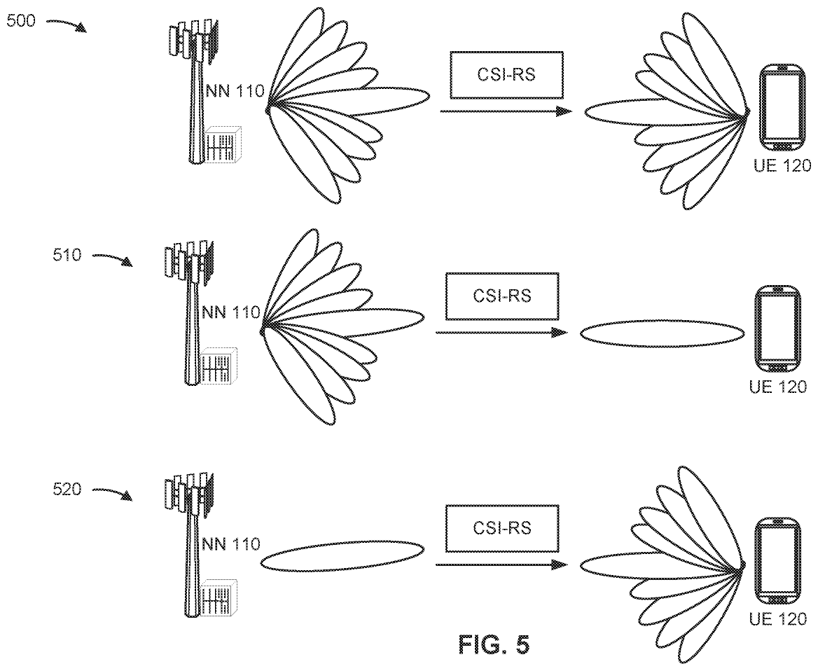

FIG. 5 is a diagram illustrating examples 500, 510, and 520 of CSI-RS beam management procedures, in accordance with the present disclosure. As shown in FIG. 5, examples 500, 510, and 520 include a UE 120 in communication with a network node 110 in a wireless network (e.g., wireless network 100). However, the devices shown in FIG. 5 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

The network node 110 may transmit a synchronization signal block (SSB) to UEs. The SSB may carry information used by a UE for initial network acquisition and synchronization, such as a PSS, an SSS, a physical broadcast channel (PBCH), and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

As shown in FIG. 5, example 500 may include a network node 110 (e.g., one or more network node devices such as an RU, a DU, and/or a CU, among other examples) and a UE 120 communicating to perform beam management using CSI-RS s. Example 500 depicts a first beam management procedure (e.g., P1 beam management). The first beam management procedure may be referred to as a beam selection procedure, an initial beam acquisition procedure, a beam sweeping procedure, a cell search procedure, and/or a beam search procedure. As shown in FIG. 5 and example 500, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple Tx beams. The network node 110 may transmit a CSI-RS using each transmit beam for beam management. To enable the UE 120 to perform Rx beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 500 has been described in connection with CSI-RS s, the first beam management process may also use SSBs for beam management in a similar manner as described above.

As shown in FIG. 5, example 510 may include a network node 110 and a UE 120 communicating to perform beam management using CSI-RS s. Example 510 depicts a second beam management procedure (e.g., P2 beam management). The second beam management procedure may be referred to as a beam refinement procedure, a network node beam refinement procedure, a TRP beam refinement procedure, and/or a transmit beam refinement procedure. As shown in FIG. 5 and example 510, CSI-RS s may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RS s (e.g., measured by the UE 120 using the single receive beam) reported by the UE 120.

As shown in FIG. 5, example 520 depicts a third beam management procedure (e.g., P3 beam management). The third beam management procedure may be referred to as a beam refinement procedure, a UE beam refinement procedure, and/or a receive beam refinement procedure. As shown in FIG. 5 and example 520, one or more CSI-RS s may be configured to be transmitted from the network node 110 to the UE 120. The CSI-RSs may be configured to be aperiodic (e.g., using DCI). The third beam management process may include the network node 110 transmitting the one or more CSI-RS s using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

Similar beam management procedures may be used for sidelink beam management operations between UEs. Sidelink beam management operations may include initial beam-pairing or beamforming, beam fine tuning, beam maintenance, and beam failure recovery. Beam fine tuning may involve selection of a beam direction and limited beam sweeping around the beam direction. The limited beam sweeping may use narrower beams and/or use more granularity in beam directions.

As indicated above, FIG. 5 is provided as an example of beam management procedures. Other examples of beam management procedures may differ from what is described with respect to FIG. 5. For example, the UE 120 and the network node 110 may perform the third beam management procedure before performing the second beam management procedure, and/or the UE 120 and the network node 110 may perform a similar beam management procedure to select a UE transmit beam.

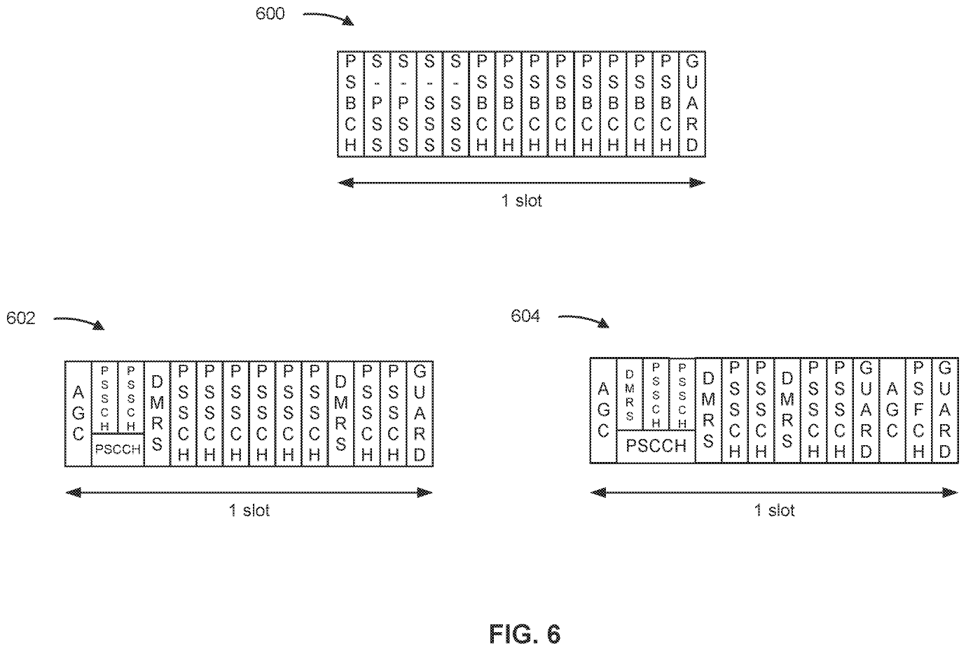

FIG. 6 is a diagram illustrating examples 600, 602, and 604 of sidelink messaging, in accordance with the present disclosure.

Sidelink beam management may involve synchronizing timing between UEs. A sidelink synchronization procedure may define a hierarchy of priorities associated with different synchronization references and requires all UEs to continuously search the hierarchy to get to the highest-quality synchronization reference that can be found. When a UE is unable to find any other synchronization reference (such as a global navigation satellite system (GNSS) or a base station) directly or indirectly (relayed), a UE may use its own internal clock to transmit an NR sidelink synchronization signal block (S-SSB). Example 600 shows that an S-SSB may include a physical sidelink broadcast channel (PSBCH), a sidelink primary synchronization signal (S-PSS), and a sidelink secondary synchronization signal (S-SSS) on almost all 14 symbols of a slot. The UE may transmit one or more S-SSBs with a period of 160 milliseconds (ms), based on a numerology used for communications on the sidelink channel.

UEs may also transmit NR SCI. Example 602 shows a first-stage SCI on a PSCCH (2 symbols), transmitted with a PSSCH. The SCI indicates the time-frequency resources reserved for future transmissions with the PSSCH. The SCI transmissions are used by sensing UEs to maintain a record of which resources have been reserved by other UEs in the recent past. For semi-persistent scheduling (SPS) on sidelink, a Resource Reservation Period field may indicate a time interval for periodic transmissions in future. Example 604 shows a 3-symbol PSCCH.

UEs may transmit an NR sidelink CSI report. For sidelink link adaptation and rank adaptation in unicast transmissions, a transmitting UE may transmit a sidelink CSI reference signal (CSI-RS) multiplexed with a PSSCH transmission. The CSI Request field (e.g., in SCI part 2) may indicate aperiodic sidelink CSI reporting from a receiving UE (via a medium access control control element (MAC CE). The transmitting UE waits to trigger the next CSI report from a given receiving UE until the preceding report has been received, or a latency bound has expired.

For Uu downlink, a base station (e.g., gNB) may sweep SSBs or CSI-RS s with different transmitting beams for beam forming and fine tuning, beam monitoring with measurements, and candidate beam detection for beam recovery. However, for sidelink communication, only synchronization reference (SyncRef) UEs are allowed to transmit a sidelink SSB due to the control of sidelink synchronization reference quality. A SyncRef UE is a UE that has not received any SSB and has determined to transmit SSBs using its own clock. A non-SyncRef UE, or a sidelink UE that does not provide synchronization assistance, may cause interference to the synchronization references while sweeping sidelink SSBs on different beams for beam management, similar to a base station sweeping SSBs periodically for beam management on a Uu interface.

For sidelink unicast, a transmitting UE may transmit a sidelink CSI-RS together with a data transmission on the PSSCH. Therefore, the transmitting UE may need to sweep sidelink CSI-RS s with different beams at the granularity of a slot. This sweeping may take multiple slots (a slot for each beam direction), which will add latency for beamforming, beam measurement, or beam recovery. Similarly, as shown by example 600, almost all 14 symbols are used for each SSB. If such an SSB is transmitted in each beam direction of a beam sweep, significant signaling resources are consumed. The resource consumption may have a greater effect in sidelink resource allocation mode 2, where there is no coordination by a base station. Sidelink SSBs may consume 3-4 times the resources as compared to beam sweeping for a Uu. The transmission of large SSBs in a beam sweeping pattern by multiple UEs also creates a great amount of interference. Additionally, with more dynamic channels in FR2 frequencies, beamforming or beam switching may occur more frequently. This may increase latency, resource usage, and interference.

As indicated above, FIG. 6 is provided as an example. Other examples may differ from what is described with regard to FIG. 6.

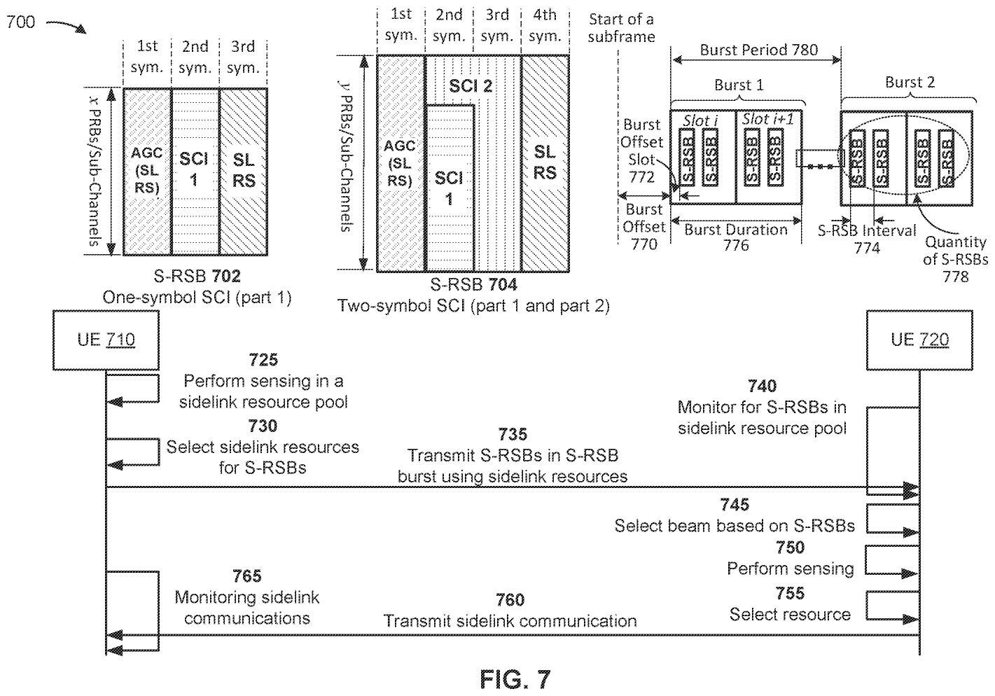

FIG. 7 is a diagram illustrating an example 700 associated with sensing and transmitting S-RSB s, in accordance with the present disclosure. As shown in FIG. 7, a first UE 710 (e.g., UE 120) and a second UE 720 (e.g., UE 120) may communicate with one another over a sidelink channel.

According to various aspects described herein, a sidelink UE may perform sensing-based beam sweeping and, based on the sensing, transmit sidelink beam management blocks, such as S-RSB s (e.g., S-RSB 702, S-RSB 704) that are shorter than the sidelink SSB 600 shown in FIG. 6. In this way, sidelink UEs may conserve power and signaling resources while reducing interference and latency.

A sidelink beam management block may include at least one beam management signal and SCI. A beam management signal may include a signal that is used for beam management, such as a reference signal or a sequence for a reference signal. In some aspects, the beam management signal may include a synchronization signal or a sequence for a synchronization signal. The sidelink beam management block may include multiple symbols, such as a symbol for the beam management signal and a symbol for the SCI. Another symbol may be for another beam management signal, such as a beam management signal for beamforming, beam fine tuning, or beam measurements.

In an example, an S-RSB may include at least one reference signal (RS) and SCI that other UEs may use for beam management (e.g., using the RS) and resource sensing for beam sweeping or sidelink communication (e.g., based at least in part on the resource reservation indicated in the SCI or measurements such as RSSI, RSRP, RSRQ or signal-to-interference-plus-noise ratio (SINR)). For example, S-RSB 702 is 3 symbols and includes a first RS that may be used for automatic gain control (AGC), a one-symbol SCI, and a second RS for other beam management operations. The second RS may be used for beamforming, beam fine tuning, and/or beam measurement. The second RS may be the same as the first RS or different than the first RS. The first RS and/or the second RS may be a Zadoff-Chu (ZC) sequence or at least one m-sequence (e.g., for a synchronization signal like sequence generated with an identifier for beam management) mapped to each resource element or subcarrier of x physical resource blocks (PRBs) or sub-channels, similar to a Uu synchronization signal. The RS may be a pseudo-random sequence mapped continuously (e.g., density as 1) or discontinuously over y PRBs or sub-channels (e.g., even PRBs with density 0.5), similar to a Uu CSI-RS (e.g., a reference signal like sequence initiated with an identifier for beam management). A ZC sequence may be used for synchronization for LTE. An m-sequence may be used for synchronization for NR. A pseudo-random sequence may be a sequence for an RS (e.g., DMRS, CSI-RS). In some aspects, a sidelink beam management block may include SCI and one or more other types of synchronization signals that can be used for sidelink beam management.

The SCI may indicate time and frequency resources reserved for one or more sidelink beam management block transmissions (e.g., S-RSB transmissions), respectively. The SCI may indicate time and frequency resources reserved for future S-RSB transmissions in one or more S-RSB bursts (e.g., aperiodic without repeating) or used for semi-persistent scheduling (SPS) of future sidelink beam management block bursts (e.g., S-RSBs bursts, semi-periodic with a repeating period or time interval), such that other UEs are aware of the one or more S-RSB bursts at the reserved resources (e.g., aperiodic) or the S-RSB transmission pattern of the S-RSB bursts (e.g., semi-periodic). The other UEs may schedule transmissions and/or receptions around the received sidelink beam management blocks (e.g., based on decoding the SCI or measuring of the received S-RSB transmissions within one or more S-RSB bursts) to avoid transmission collisions (e.g., collisions between S-RSB bursts from different UEs or collisions between S-RSB bursts and other sidelink communications such as beam report from different UEs). Additionally, The SCI may include beam information (e.g., transmission configuration indicator (TCI) state with quasi-co-location (QCL) types such as type A or type D or spatial filter for a special receive beam parameter or for beam association or correspondence, a beam identifier or beam index of a beam used to transmit the sidelink beam management block for beam association or resource mapping) and sidelink beam management block information, such as S-RSB information (e.g., S-RSB index of an S-RSB within an S-RSB burst for beam association or resource mapping, S-RSB structure or configuration for a UE to identify the proper S-RSB burst). The S-RSB structure or configuration information may include an S-RSB configuration index (e.g., a codepoint of S-RSB burst duration and S-RSB burst period combined, based at least in part on a numerology configured for a sidelink bandwidth part (BWP)). The SCI may include a source identifier (ID), such as a Layer 1 (L1) source ID for identifying the transmitter of the one or more sidelink beam management block bursts (e.g., S-RSB bursts). For example, an Rx UE may determine whether to pair a receive beam with the Tx UE's transmit beam and whether to report the beam measurement to the Tx UE based at least in part on the Tx UE's ID. The SCI may include a destination ID, such as an L1 destination ID for identifying an Rx UE with which the Tx UE may conduct beam sweeping for transmitting beam fine tuning or receiving beam fine tuning. The SCI may indicate a type of beam management operation, whether initial beamforming, beam fine tuning of transmit (Tx) beams, beam fine tuning of receive (Rx) beams, beam measurements, or beam recovery (e.g., an Rx UE may detect the proper S-RSB burst(s) for beamforming or beam fine tuning). In another example, S-RSB 704 spans 4 symbols and includes 2 symbols of SCI. The SCI may include SCI part 1 and SCI part 2. The SCI part 2 (carried on PSSCH as shown in FIG. 6) may indicate preferred resources or non-preferred resources associated with the S-RSB of an S-RSB burst. Alternatively, the SCI part 2 may include the source ID, the destination ID, and/or other identifiers or information for a beam management operation. If the S-RSB is 4 symbols, the SCI part 2 may be included in the third symbol (and possibly part of the second symbol). The second RS may be included in the fourth symbol. In some aspects, the RS signal may be interleaved with the SCI part 1 and/or SCI part 2 with a comb structure.

Example 700 shows sensing that involves beam sweeping with the transmission of sidelink beam management blocks, such as S-RSBs. As shown by reference number 725, UE 710 may perform sensing (e.g., based at least in part on decoding the SCI with each S-RSB for reserved resources and/or a sidelink RSRP, RSSI, or RSRQ measurement) to sense or detect the resources reserved or resource patterns of S-RSB bursts transmitted or to be transmitted by other UEs in a sidelink resource pool. UE 710 may then select the resources or resource patterns, from within the sidelink resource pool, that can be used for transmitting one or more S-RSB bursts without colliding with other UE's S-RSB bursts. This may include sensing using beam sweeping in multiple directions, such as covering the angular range of S-RSB bursts of UE 710. As shown by reference number 730, UE 710 may select sidelink resources (e.g., time and frequency resources) for S-RSBs based at least in part on the selected resources or resource patterns available for transmitting one or more S-RSB bursts. UE 720 may select the sidelink resources from the sidelink resource pool so as to avoid colliding with other UE's S-RSB bursts over the same resources with a certain beam direction.

As shown by reference number 735, UE 710 may transmit one or more S-RSBs in one or more S-RSB bursts in a beam sweeping pattern. UE 710 may transmit the S-RSBs using the selected sidelink resources. Each S-RSB may have an S-RSB index or S-RSB resource indication within an S-RSB burst (e.g., for beam association or resource mapping). An S-RSB burst may be structured or configured with a burst offset 770 (e.g., a starting point within a subframe or a frame), a burst offset slot 772 (e.g., a starting point within a slot), an S-RSB interval 774 between adjacent S-RSBs (e.g., in symbols), a burst duration 776 of the S-RSB burst (e.g., in slots or subframes, in frames, in absolute time), a quantity of S-RSBs 778 within the S-RSB burst, and/or a burst period 780 (e.g., time period in slots, subframes, frames or absolute time) between S-RSB bursts. There may be an S-RSB burst structure or configuration for beamforming and an S-RSB burst structure or configuration for other operations such as beam fine tuning. An S-RSB within the S-RSB burst may indicate the structure or configuration information (e.g., S-RSB configuration index). Additionally or alternatively, an S-RSB burst structure or configuration may be specified, preconfigured or configured for one or more sidelink services based at least in part on a numerology with a sidelink BWP. In this case, a UE may select resources for one or more S-RSB bursts based at least in part on the S-RSB burst structure or configuration with the associated resources in a resource pool without SCI-based resource sensing and selecting (e.g., the SCI may be excluded in the S-RSB transmissions of one or more S-RSB bursts).

UE 710 may transmit the one or more S-RSB bursts in the sidelink resource pool. The sidelink resource pool may be for sidelink beam management. The sidelink resource pool may be dedicated for S-RSB bursts. The sidelink resource pool for S-RSB bursts may be frequency division multiplexed (FDMed) or time division multiplexed (TDMed) with other transmission and/or reception pools. As shown by reference number 740, UE 720 may be monitoring for S-RSBs in the sidelink resource pool.

In some aspects, UE 720 may receive the one or more S-RSB bursts using a receive beam (e.g., using a receive beam for one or more S-RSB bursts with a set of transmit beams) or a receive beam sweep pattern (e.g., using a first receive beam for a first S-RSB burst with a set of transmit beams, a second receive beam for a second S-RSB burst with the set of transmit beams, and so forth). A receive beam sweep pattern may also be used for receive beam fine tuning (e.g., sweeping receive beams for an S-RSB burst with a fixed transmit beam). As shown by reference number 745, UE 720 may select a beam based at least in part on the S-RSBs. UE 720 may select the beam based at least in part on measurements of S-RSBs in the one or more S-RSB bursts (e.g., the beam with the highest RSRP, RSRQ, SINR measurement or a beam with RSRP, RSRQ, or SINR measurement is above a threshold that is preconfigured, configured, or activated). UE 720 may select an S-RSB or a beam associated with an S-RSB of the one or more S-RSB bursts using a receiving beam that is paired to the selected beam as part of a beam-pair link. The S-RSB with the best measurement may be associated with the best transmit beam or receive beam for beam selection during the initial beam forming or transmit/receive beam fine tuning or candidate beam selection of beam recovery.

The measurements of different S-RSBs associated with different beams for beam monitoring may be used for determining beam switching during the beam maintenance or beam recovery based on the reported measurements. Some examples are provided. In some aspects associated with initial beam forming, UE 720 may sweep transmit beams with different S-RSB transmissions in an S-RSB burst. UE 720 (receiving UE for S-RSB transmissions) may use a first receive beam to measure all S-RSBs transmitted on different transmit beams of UE 710 (transmitting UE for S-RSB transmissions) during a first S-RSB burst and select a first transmit beam associated with a first S-RSB with first best measurements (e.g., highest RSRP, RSRQ, or SINR). UE 720 may use a second receive beam to measure all S-RSB s transmitted on different transmit beams of UE 710 during a second S-RSB burst and select a second transmit beam associated with a second S-RSB with second best measurements and so on. UE 720 may select the best transmit beam of the first transmit beam, second transmit beam, and so forth with the highest measurement of the first best measurement, second best measurement, and so on. UE 720 may select the receive beam used to measure the S-RSB associated with the best transmit beam or select the best receive beam of the first receive beam, second receive beam, and so on based at least in part on the best measurement.

In some aspects associated with initial beam forming, UE 720 may sweeping receive beams with same S-RSB transmission on a transmit beam in an S-RSB burst. UE 720 (receiving UE for S-RSB transmissions) may use a first receive beam to measure a first S-RSB and a second Rx beam to measure a second S-RSB and so on, where all S-RSBs are transmitted on a first transmit beam of UE 710 (transmitting UE for S-RSB transmissions) with a first S-RSB burst, and select a first receive beam associated with first best measurements (e.g., highest RSRP, RSRQ, or SINR) of a first S-RSB burst on a first transmit beam. UE 720 may select a second receive beam associated with second best measurements of a second S-RSB burst on a second transmit beam and so on. UE 720 may select best receive beam of the first receive beam, second receive beam, and so on with the highest measurement of the first best measurement, second best measurement, and so on. UE 720 may select the transmit beam used to transmit the S-RSB burst associated with the highest measurement (e.g., select best transmit beam of the first transmit beam, second transmit beam, and so on).

In some aspects associated with transmit beam fine tuning with a receive beam, UE 720 may sweeping transmit beams with different S-RSB transmissions in one or multiple S-RSB bursts (monitoring using a receive beam), and select the best transmit beam associated with the S-RSB with the best measurement. In some aspects associated with receive beam fine tuning with a transmit beam, UE 720 may sweep receive beams with the same S-RSB transmission on a transmit beam in one or multiple S-RSB bursts, and select the best receive beam associated with the S-RSB with the best measurement.

In some aspects associated with transmit beam monitoring with a receive beam, similar to transmit beam sweeping or monitoring for transmit beam fine tuning, the report may include measurements of all transmit beams (not the selected transmit beam based on the best measurement). In this case, the transmit beam switching may be determined by UE 710 based on the received measurement reports. In some aspects associated with candidate beam selection for beam recovery, UE 720 may sweep transmit beams like transmit beam fine tuning or sweep receive beams like receive beam fine tuning or sweep both transmit beam and receive beam like initial beam forming. The report may include selected transmit or receive beam like initial beam forming or transmit/receive beam fine tuning (beam selection is done by UE 720), or beam measurements like beam monitoring (beam selection is done by UE 710 based on the received measurement reports).

UE 720 may communicate using the selected beam. For example, in some aspects, UE 720 may perform sensing for the sidelink communication, as shown by reference number 750. As shown by reference number 755, UE 720 may select a resource (e.g., time and frequency) for the sidelink communication based at least in part on the selected beam. UE 720 may sense and select the resource from a resource set based at least in part on a configured time duration after the S-RSB of the one or more S-RSBs in the one or more S-RSB bursts, a mapping of the resource set with the S-RSB of the one or more S-RSBs in the one or more S-RSB bursts, and/or SCI part 2 included in the S-RSB of the one or more S-RSBs in the one or more S-RSB bursts. The S-RSB may be associated with the selected beam as described in connection with reference number 745. UE 720 may map the resource set to an S-RSB of the S-RSB burst based at least in part on a received beam ID, a beam index, or an S-RSB index or S-RSB resource indication as preconfigured or configured with the S-RSB structure or configuration or dynamically indicated in an S-RSB associated with the selected beam.

As shown by reference number 760, UE 720 may transmit a sidelink communication using the beam and the resource. The sidelink communication may be a discovery message (e.g., peer discovery or relay UE discovery after the initial beamforming), a direct communication request (DCR) (e.g., to establish a PC5 RRC connection after the initial beamforming), or a beam report (e.g., report the selected Tx beam(s) and/or the associated sidelink beam pair(s) or sidelink beam pair links after the initial beamforming). UE 720 may transmit the sidelink communication using a transmitting beam that is associated with or corresponds to a receive beam of UE 720 paired with the selected transmit beam from UE 710. UE 720 may determine the transmitting beam based at least in part on a selected beam ID, a selected beam index, an S-RSB index or S-RSB resource indication associated with a selected beam as preconfigured, configured, or indicated in S-RSB, a TCI state (e.g., QCL type for the RS of UE 720) as preconfigured, configured, or indicated by SCI in an S-RSB associated with the selected beam, and/or a spatial filter (e.g., beamforming parameters) as preconfigured, configured, or indicated in the S-RSB. As shown by reference number 765, UE 710 may be monitoring for a sidelink communication based at least in part on each S-RSB of the one or more S-RSBs of the one or more S-RSB bursts. UE 710 may be monitoring for the sidelink communication in one or more resource sets (in the sidelink resource pool) based at least in part on a configured time duration after each S-RSB of the one or more S-RSBs in the one or more S-RSB bursts, a mapping of each resource set of the one or more resource sets with a respective S-RSB of the one or more S-RSBs in the one or more S-RSB bursts, and/or SCI part 2 included in each S-RSB of the one or more S-RSBs in the one or more S-RSB bursts. UE 710 may be monitoring for a sidelink communication using one or more receiving beams that are based at least in part on one or more respective transmitting beams (e.g., based on beam correspondence) that are associated with each S-RSB of the one or more S-RSBs in the one or more S-RSB bursts. UE 710 may receive the sidelink communication.

As a result of sensing-based transmission of S-RSB bursts, the sidelink communications between UE 710 and UE 720 with other sidelink UEs improve because there will be less interference. With the S-RSBs being of a smaller size than sidelink SSBs, less signaling resources are used, latency is reduced, and power is conserved, which improves the overall sidelink system resource utilization and performance.

As indicated above, FIG. 7 is provided as an example. Other examples may differ from what is described with respect to FIG. 7.

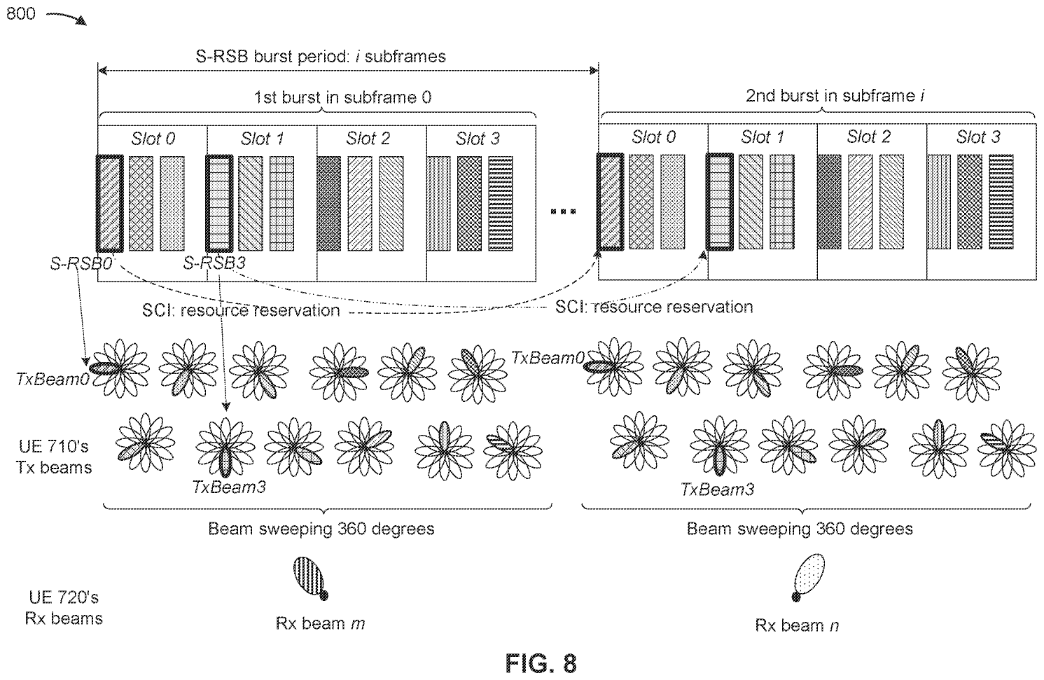

FIG. 8 is a diagram illustrating an example 800 of a beam sweeping pattern for beamforming, in accordance with the present disclosure.

A UE may transmit a long sidelink beam management block burst (e.g., S-RSB burst) with multiple sidelink beam management block transmissions (e.g., S-RSB transmissions) on multiple respective beams of the beam sweeping pattern. The beam sweeping pattern may include a wide range of beam directions. For example, the S-RSB burst for beamforming may be specified, preconfigured, or configured (e.g., via system information such as SIB12 or SIB x or common or broadcast RRC message) so that all UEs supporting FR2 for sidelink communications may acquire such information for initial beamforming or pairing on sidelink. The information may include, for example, a burst offset, a burst offset in slot, a burst duration, a burst period, a quantity of repeated S-RSBs per burst, and/or an S-RSB interval. Example 800 shows beamforming with the burst offset of 0 slots (e.g., starting from the first slot of a subframe) and a burst offset in the slot of 0 symbols (e.g., starting from the first symbol of a slot), the burst duration of 4 slots, the burst period of i subframes or i ms in time, 12 S-RSBs per bursts, and the S-RSB interval of 4 symbols (using 3-symbol S-RSB). The burst duration may be long with a wide Tx beam sweeping angular range for beamforming or beam pairing. For example, the burst duration of an S-RSB burst for beamforming may include 12 S-RSBs in 4 slots, with 3 RSBs in a slot. In a sidelink BWP with an FR2 numerology of 60 kHz subcarrier spacing (SCS), there may be 4 slots per subframe. Each S-RSB of the S-RSB burst is transmitted in a Tx beam and thus the beam sweeping pattern in example 800 includes 12 beams in a 360 degree pattern. For example, S-RSB0 is transmitted in one beam direction (TxBeam0) and S-RSB3 is transmitted in another beam direction (TxBeam3) that is the 4th beam in the beam sweeping pattern. The S-RSB burst duration in example 800 is 4 slots, 1 subframe, or 1 ms with 12 3-symbol S-RSBs. In some aspects, the S-RSB burst duration may be reduced with a smaller size of S-RSBs (e.g., 2-symbol S-RSB with SCI part 1 or SCI part 2 on PSSCH and RS interleaved or without SCI part 1 and SCI part 2 on PSSCH symbols) based at least in part on the structure or configuration of the S-RSB burst that is preconfigured or configured.

The S-RSB burst period may be a quantity of i subframes or slots or a time duration of i ms, which may be used for semi-persistent S-RSB bursts using SPS based resource reservation as indicated in the SCI. The SCI of S-RSB0 in the first burst may indicate the S-RSB0 transmission in the second burst at the resource reserved with the Resource Reservation Period field set with the S-RSB burst period, or the SCI of S-RSB3 in the first burst may indicate the S-RSB3 transmission in the second burst at the resource reserved with the Resource Reservation Period field set with the S-RSB burst period. In some aspects, the S-RSB burst period may be used for one or more S-RSB bursts using the resource reservation as indicated in the SCI. The SCI of S-RSB0 in the first burst may indicate the S-RSB0 transmission in the second burst at the resource reserved based at least in part on the S-RSB burst period, or the SCI of S-RSB3 in the first burst may indicate the S-RSB3 transmission in the second burst at the resource reserved based at least in part on the S-RSB burst period. Example 800 also shows receiving beams (e.g., sweeping receive beams) that a receiving UE is using (e.g., Rx beam m for the first S-RSB burst and Rx beam n for the second S-RSB burst). In some aspects, the receiving UE may select a first Tx beam (e.g., TxBeam1) associated with the S-RSB of the first S-RSB burst with the first best (preferred) beam measurement (e.g., RSRP1 or RSRQ1) using a first Rx beam (e.g., RxBeam1) and a second Tx beam (e.g., TxBeam2) associated to the S-RSB of the second S-RSB burst with the second best beam measurement (e.g., RSRP2 or RSRQ2) using a second Rx beam (e.g., RxBeam2). The receiving UE may determine a best Tx beam and the associated beam pair based at least in part on comparing the first and the second best beam measurements (e.g., TxBeam1 as the best Tx beam and TxBeam1 and RxBeam1 as the associated beam pair if the first best beam measurement is better than the second one). The first Tx beam and the second Tx beam may be same or different with different Rx beams or the first Rx beam. The second Rx beam may be same or different with different Rx beams or any other combinations.

In some aspects, the receiving UE may report the selected best Tx beam (e.g., from one antenna or panel) and/or the associated respective sidelink beam pair or sidelink beam pair link to the transmitting UE using the transmitting beam corresponding to the receiving beam (e.g., based at least in part on the beam correspondence) paired with the selected best Tx beam at the resource set associated or mapped with the selected best Tx beam, after the beam pairing or beamforming. In some aspects, the receiving UE may report multiple selected best Tx beams (e.g., from different antennas or panels) and/or the associated respective sidelink beam pairs or sidelink beam pair links to the transmitting UE using the transmitting beam corresponding to the receiving beam (e.g., based at least in part on the beam correspondence) paired with one of the multiple selected best Tx beams at the resource set associated or mapped with one of the multiple selected best Tx beams (e.g., based on the highest RSRP or RSRQ measurement, available resources in one of the resource sets, channel congestion level such as CBR measurement, etc.). The receiving UE may use multiple transmitting beams corresponding respectively to multiple receiving beams (e.g., beam correspondence with different antennas or panels) paired with the multiple selected best Tx beams at the resource sets associated or mapped respectively with the multiple selected best Tx beams, after the beam pairing or beamforming.

In some aspects, a receiving UE (e.g., UE 720 as shown in FIG. 7) may monitor different S-RSB bursts from different Tx UEs (e.g., UEs 710 as shown in FIG. 7) identified respectively by the source ID indicated in the SCI of each S-RSB of the different S-RSB bursts. The receiving UE may select multiple Tx beams respectively associated to multiple Tx UEs and report the selected multiple Tx beams respectively to the multiple Tx UEs using multiple transmitting beams corresponding respectively to multiple receiving beams (e.g., based on the beam correspondence) paired with the multiple selected Tx beams at the resource sets associated or mapped respectively with the multiple selected Tx beams, after the beam pairing or beamforming.

In some aspects, multiple receiving UEs (e.g., UEs 720 as shown in FIG. 7) may monitor for the same S-RSB burst(s) from one Tx UE (e.g., UE 710 as shown in FIG. 7) identified by the source ID indicated in the SCI of each S-RSB of the S-RSB burst(s). The multiple UEs may select one or multiple Tx beams with the Tx UE. Similarly, each receiving UE may report one or multiple selected Tx beams and/or the associated respective sidelink beam pairs or sidelink beam pair links to the transmitting UE using the transmitting beam corresponding to the receiving beam (e.g., based at least in part on the beam correspondence) paired with one of the one or multiple selected Tx beams at the resource set associated or mapped with one of the one or multiple selected best Tx beams (e.g., based on the highest RSRP or RSRQ measurement, available resources in one of the resource sets, channel congestion level such as CBR measurement). The receiving UE may use multiple transmitting beams corresponding respectively to multiple receiving beams (e.g., beam correspondence with different antennas or panels) paired with the multiple selected Tx beams at the resource sets associated or mapped respectively with the multiple selected best Tx beams, after the beam pairing or beamforming. The transmitting UE may monitor for transmissions from multiple receiving UEs at each resource set associated or mapped with each S-RSB of its one or more S-RSB bursts using the receiving beams corresponding to the transmitting beams respectively associated with S-RSBs of the one or more S-RSB bursts.

As indicated above, FIG. 8 is provided as an example for beamforming. Other examples may differ from what is described with regard to FIG. 8.

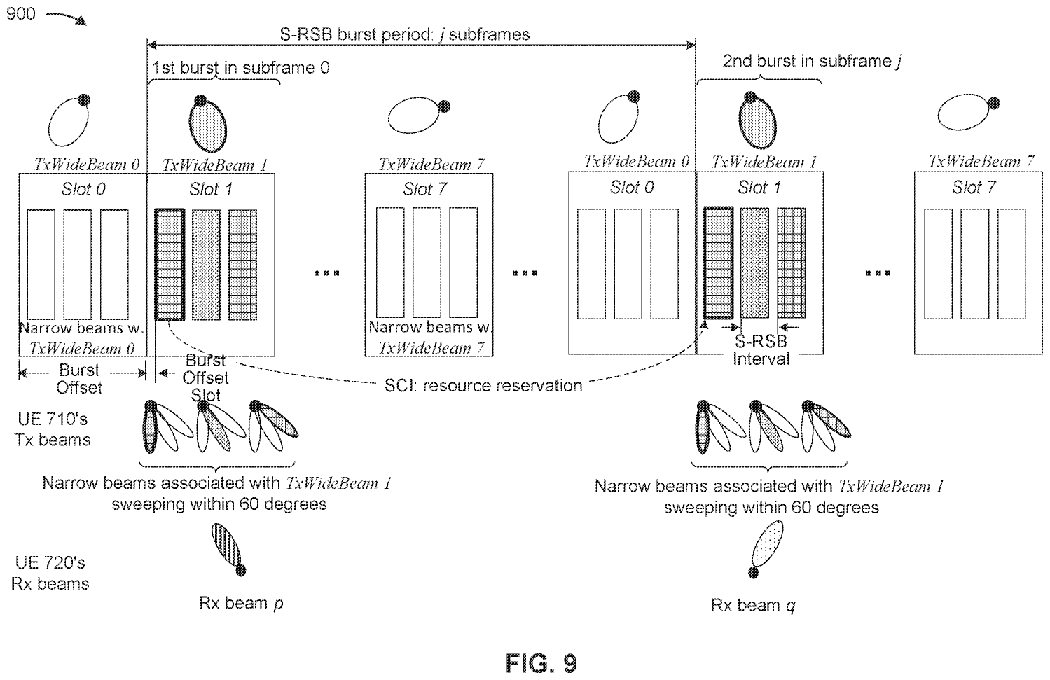

FIG. 9 is a diagram illustrating an example 900 of a beam sweeping pattern for beam fine tuning, in accordance with the present disclosure. The beam fine tuning may be for a transmit (Tx) beam.

The Tx beam sweeping with a fixed Rx beam for beam fine tuning of a transmit beam may include fewer sidelink beam management blocks (e.g., S-RSBs) associated with fine Tx beams in a narrow angular range of Tx beam directions. The sidelink beam management block burst (e.g., S-RSB burst) for Tx beam fine tuning may be preconfigured or configured (e.g., via a common or a broadcast RRC message for UEs in the coverage of the network, via a UE dedicated RRC message for a specific UE that is identified by the destination ID in the S-RSB within an S-RSB burst). The S-RSB burst may use, for example, a burst offset and a burst offset in slot. The S-RSB burst may have a burst duration, a burst period, a quantity of S-RSBs per burst, and/or S-RSB interval. Example 900 shows a Tx beam fine tuning S-RSB burst with a burst offset of 1 slot (e.g., starting from the second slot of a subframe), a burst offset in slot of 1 symbol (e.g., starting from the second symbol of a slot), a burst duration of 1 slot, a burst period of j slots or subframes or j ms in time, 3 S-RSBs per burst, and the S-RSB interval of 4 symbols (using 3-symbol S-RSB). The burst duration may be short with a narrow, fine Tx beam sweeping angular range for fine tuning a Tx beam in a direction (e.g., associated with a Tx wide beam). For example, the 3 S-RSBs (using 3-symbol S-RSB) in 3 fine beams in slot 1 of subframe 0 or subframe j may be swept in a certain direction (e.g., associated with a Tx beam TxWideBeam 1). There may be multiple S-RSB transmissions on multiple respective fine beams, but the intra-burst Tx beam sweeping may be in a narrow range of directions. The quantity of beams and/or the angular degrees (e.g., within 90 degrees) of the beam sweeping pattern for beam fine tuning may be configured via signaling or stored preconfigured information. In example 900, the angular range of the beam sweeping pattern is 60 degrees with a sidelink FR2 numerology (e.g., SCS=120 kHz with 8 slots per subframe). Additionally, the SCI of an S-RSB of a first burst (e.g., the first S-RSB of the first burst in slot 1 of subframe 0) may indicate the resource reserved for the first S-RSB transmission in a second burst (e.g., the first S-RSB of the second burst in slot 1 of subframe j) based on the burst period j subframes or j ms.

As indicated above, FIG. 9 is provided as an example. Other examples may differ from what is described with regard to FIG. 9.

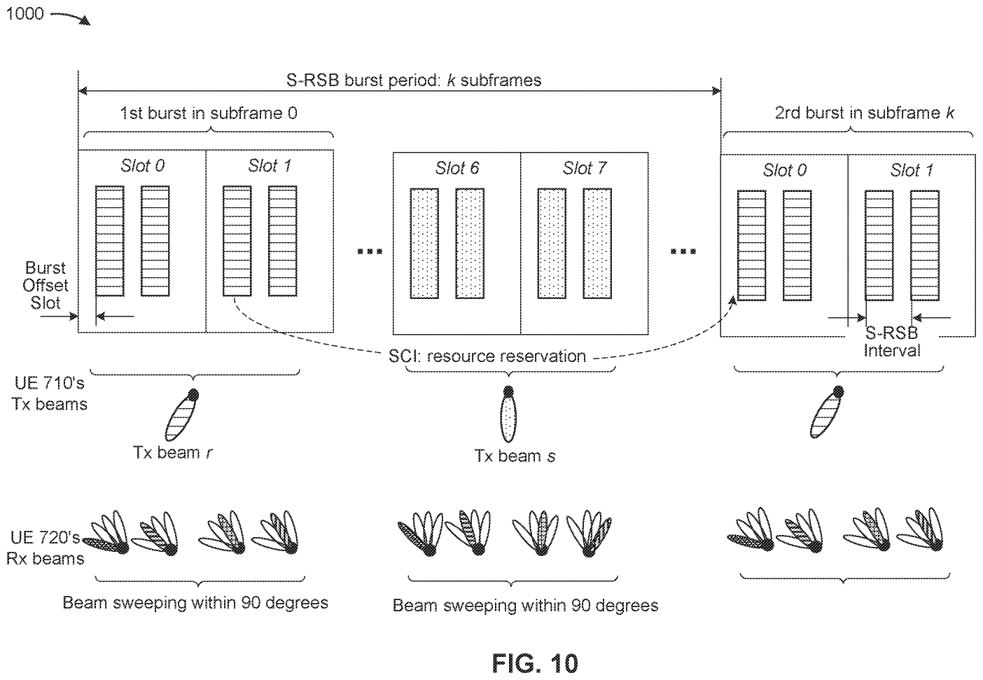

FIG. 10 is a diagram illustrating an example 1000 of a beam sweeping pattern for beam fine tuning, in accordance with the present disclosure. The beam fine tuning may be for a receive (Rx) beam.

The Rx beam sweeping with a fixed Tx beam for beam fine tuning of a receive beam may include fewer repeated sidelink beam management blocks (e.g., S-RSBs) in a short sidelink beam management block burst (e.g., S-RSB burst). The S-RSB burst for Rx beam fine tuning may be preconfigured or configured (e.g., via common or broadcast RRC message for UEs in the coverage of the network or via UE dedicated RRC message for a specific UE). The S-RSB burst may be identified by the destination ID in the SCI of an S-RSB within an S-RSB burst. The S-RSB burst may use a burst offset, a burst offset in a slot, a burst period, and/or an S-RSB interval. The S-RSB burst may have a burst duration or a quantity of repeated S-RSBs per. Example 1000 shows an Rx beam fine tuning S-RSB burst with the burst offset of 0 slot (e.g., starting from the first slot of a subframe), a burst offset in a slot of 1 symbol (e.g., starting from the second symbol of the slot), the burst duration of 2 slots, the burst period of k subframes or k ms in time, 4 S-RSBs per burst, and the S-RSB interval of 5 symbols (using 4-symbol S-RSB). The burst duration may be short with a narrow fine Rx beam sweeping angular range for fine tuning Rx beam in a direction (e.g., associated with a Tx beam). For example, the Rx sweeping pattern may be within 90 degrees with a short S-RSB burst of 4 repeated S-RSBs over 2 slots (e.g., slot 0 and slot 1 of subframe 0 or subframe k). In some aspects, S-RSBs in an Rx beam fine tuning burst may include repetitions of the same S-RSB. The S-RSB burst duration is four 4-symbol S-RSBs in two slots, transmitted on a Tx beam (e.g., Tx beam r) in 2 slots based on a sidelink FR2 numerology (e.g., SCS=120 kHz with 8 slots per subframe). Additionally, the SCI of an S-RSB of a first burst (e.g., the first S-RSB of the first burst in slot 0 of subframe 0) may indicate the resource reserved for the first S-RSB transmission in a second burst (e.g., the first S-RSB of the second burst in slot 0 of subframe k) based at least in part on the burst period k subframes or k ms in time.

As indicated above, FIG. 10 is provided as an example. Other examples may differ from what is described with regard to FIG. 10.

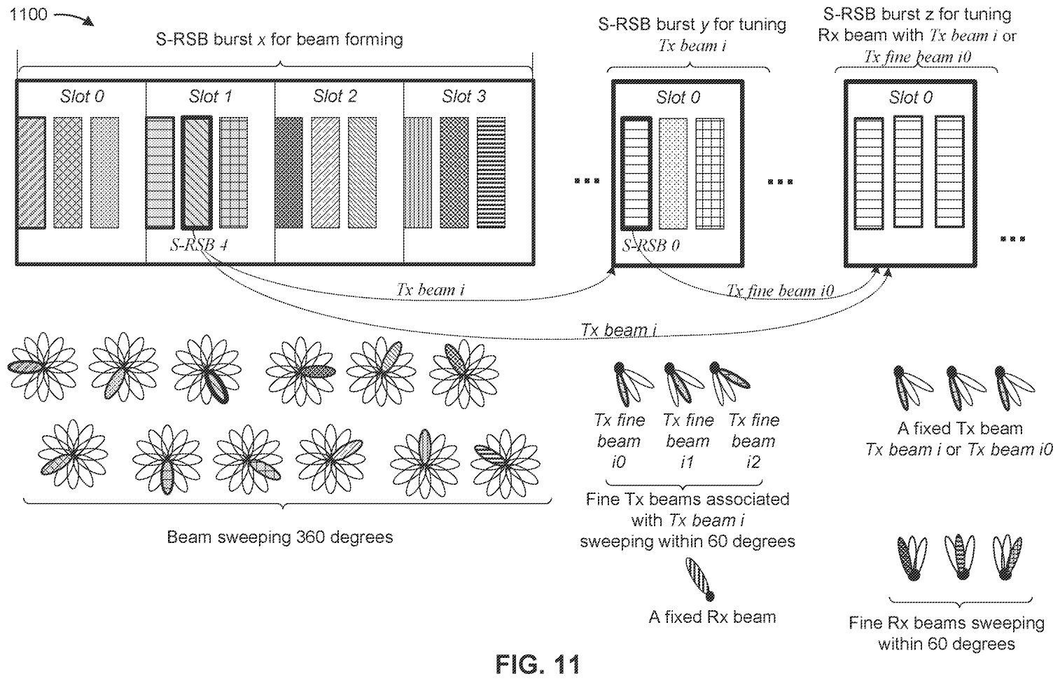

FIG. 11 is a diagram illustrating an example 1100 of the association between sidelink beam management block bursts (e.g., S-RSB burst(s)) for beam forming and S-RSB burst(s) for Tx or Rx beam fine tuning with different beam sweeping patterns, in accordance with the present disclosure. Example 1100 shows a first beam sweeping pattern for beam forming and a second beam sweeping pattern for Tx beam fine tuning and a third beam sweeping pattern for Rx beam fine tuning. There may be one or more S-RSB bursts for beam forming, one or more S-RSB bursts for beam fine tuning of Tx beams, and one or more S-RSB bursts for beam fine tuning of Rx beams. The association between different types of S-RSB bursts may be specified, preconfigured or configured, for example, via common or broadcast RRC message for all UEs in the coverage of the network or dedicated RRC message for a specific UE (e.g., identified by the destination ID in the S-RSB within an S-RSB burst), with a specified association or a mapping.

For a Tx beam associated with an S-RSB of a beamforming S-RSB burst (e.g., Tx beam i of S-RSB burst x), there is an S-RSB burst for beam fine tuning the Tx beam (e.g., S-RSB burst y associated with Tx beam i) by, for example, mapping via a time interval and/or frequency offset (e.g., preconfigured or configured) or via a mapping table with time and frequency resource allocation (e.g., preconfigured or configured) indexed with the Tx beam's ID or index or the index of the S-RSB or the resource indication of S-RSB associated with the Tx beam. For a Tx beam associated with an S-RSB of a beamforming S-RSB burst (e.g., the Tx beam i of S-RSB burst x) or an S-RSB with a Tx beam of a beamforming S-RSB burst (e.g., the S-RSB 4 with Tx beam i of S-RSB burst x), there is an S-RSB burst for beam fine tuning the Tx beam (e.g., S-RSB burst y associated with Tx beam i or S-RSB 4) by mapping, for example, via a time interval and/or frequency offset (e.g., preconfigured or configured) or a mapping table with time and frequency resource allocation (e.g., preconfigured or configured) indexed with the Tx beam's ID or index (e.g., Tx beam i) or the associated S-RSB's index (e.g., the S-RSB 4). For a Tx beam associated with an S-RSB of a beamforming S-RSB burst (e.g., the Tx beam i of S-RSB burst x) or an S-RSB with a Tx beam of a beamforming S-RSB burst (e.g., the S-RSB 4 with Tx beam i of S-RSB burst x), or, for a Tx fine beam associated with an S-RSB of a Tx beam fine tuning S-RSB burst (e.g., the Tx fine beam i0 of S-RSB burst y) or an S-RSB with a Tx beam fine tuning S-RSB burst (e.g., S-RSB0 with Tx fine beam i0 of S-RSB burst y), there is an S-RSB burst for beam fine tuning the Rx beams with the Tx beam or the Tx fine beam (e.g., S-RSB burst z associated with Tx beam i or Tx fine beam i0). The beam fine tuning may involve mapping, for example, via a time interval and/or frequency offset (e.g., preconfigured or configured) or a mapping table with time and frequency resource allocations (e.g., preconfigured or configured) indexed with the Tx beam's ID or index (e.g., the Tx beam i of S-RSB burst x) or the Tx fine beam's ID or index (e.g., the Tx fine beam i0 of S-RSB burst y) or the associated S-RSB's index (e.g., S-RSB4 with Tx beam i of S-RSB burst x or S-RSB0 with Tx fine beam i0 of S-RSB burst y). The operations described with regard to FIG. 8 may be used for S-RSB burst x for beam forming, the operations described with regard to FIG. 9 may be used for S-RSB burst y for tuning Tx beam i, and the operations described with regard to FIG. 10 may be used for S-RSB burst z for tuning Tx beam i Tx fine beam i0.

As indicated above, FIG. 11 is provided as an example. Other examples may differ from what is described with regard to FIG. 11.

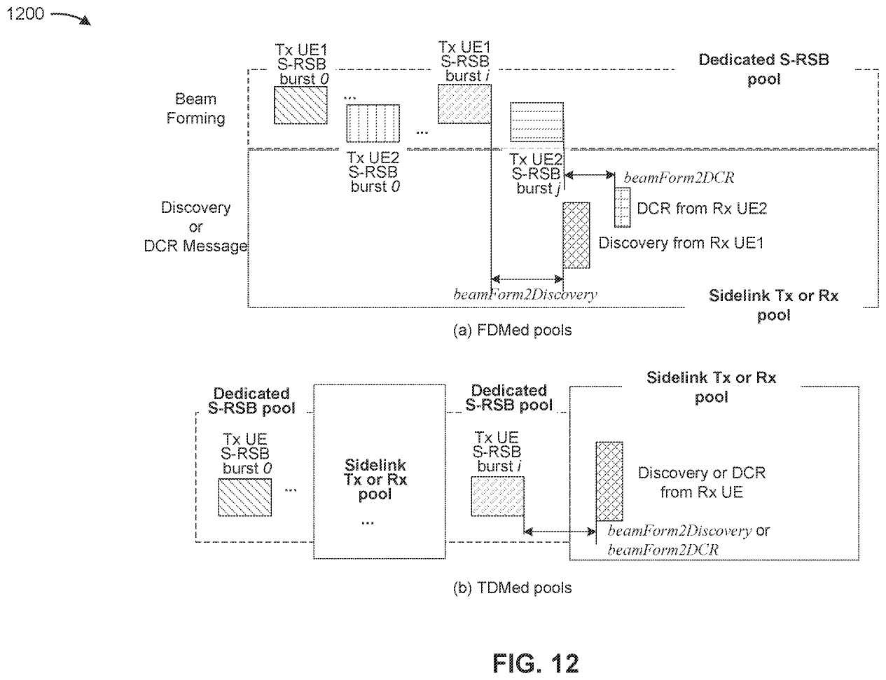

FIG. 12 is a diagram illustrating an example 1200 of a resource pool for S-RSB, in accordance with the present disclosure.

Example 1200 shows a dedicated resource pool for sidelink beam management block bursts (e.g., S-RSB bursts) may be FDMed or TDMed with one or more sidelink communication transmission and/or reception pools. A UE may use a timeline (e.g., configured via signaling or stored preconfigured information) to switch from the dedicated resource pool for beam forming to a transmission or reception pool for transmitting or receiving a sidelink communication such as a discovery message (e.g., beamForm2Discovery), a DCR (e.g., beamForm2DCR), or a beam measurement report. In some aspects, the dedicated resources or a resource pool may be preconfigured or configured based at least in part on an S-RSB burst structure or configuration for beam management (e.g., initial beam forming, beam fine tuning, beam monitoring or beam recovery), for example, after one or more S-RSB bursts (e.g., a set of bursts containing one or more S-RSB bursts), where the one or more S-RSB bursts may be semi-persistent (e.g., S-RSB bursts for initial beam forming or beam fine tuning or beam monitoring at resources reserved with resource reservation period for SPS scheduling) or event triggered (e.g., S-RSB bursts for beam fine tuning or beam recovery, such as if beam measurement is below a threshold, at resources selected and/or reserved).

In some aspects, a UE may switch between the dedicated resources or the resource pool (e.g., for S-RSB sweeping from a first UE and monitoring by a second UE) and shared transmit and receive resources or resource pool (e.g., for transmitting from the second UE or monitoring by the first UE a beam report, discovery or direct communication request message, or other sidelink communication). In some aspects, a UE may switch to the resources or resource pool of S-RSB bursts for initial beam forming and then to resources or resource pool for beam report (e.g., selected transmit beam and/or receive beam) or discovery or direct communication message, for example, based at least in part on the determination for initial beam forming. In some aspects, a UE may switch to the resources or resource pool of S-RSB bursts for beam fine tuning or beam monitoring and then to resources or resource pool for beam report or beam measurement, for example, based on configuration for beam fine tuning or beam monitoring. In some aspects, a UE may be triggered to switch to resources or resource pool for S-RSB bursts for beam fine tuning or beam recovery and then to resources or resource pool for beam report or beam measurement, for example, if beam measurement is below a threshold or beam failure is detected.

A receiving UE may use one or more transmitting beams respectively associated with one or more selected Tx beams from the transmitting UE in a range of resources (e.g., a resource set) mapped with the one or more selected Tx beams or the S-RSBs respectively associated with the one or more selected Tx beams or indicated in the SCI part 2 transmitted with each S-RSB of the S-RSBs respectively associated with the one or more selected Tx beam. A transmitting UE may use receiving beams respectively associated with its Tx beams or S-RSBs of its S-RSB burst at resources (e.g., resource sets) mapped with its Tx beams S-RSBs of its S-RSB burst or indicated in SCI part 2 transmitted with each S-RSB of the S-RSBs of its S-RSB burst.

As indicated above, FIG. 12 is provided as an example. Other examples may differ from what is described with regard to FIG. 12.

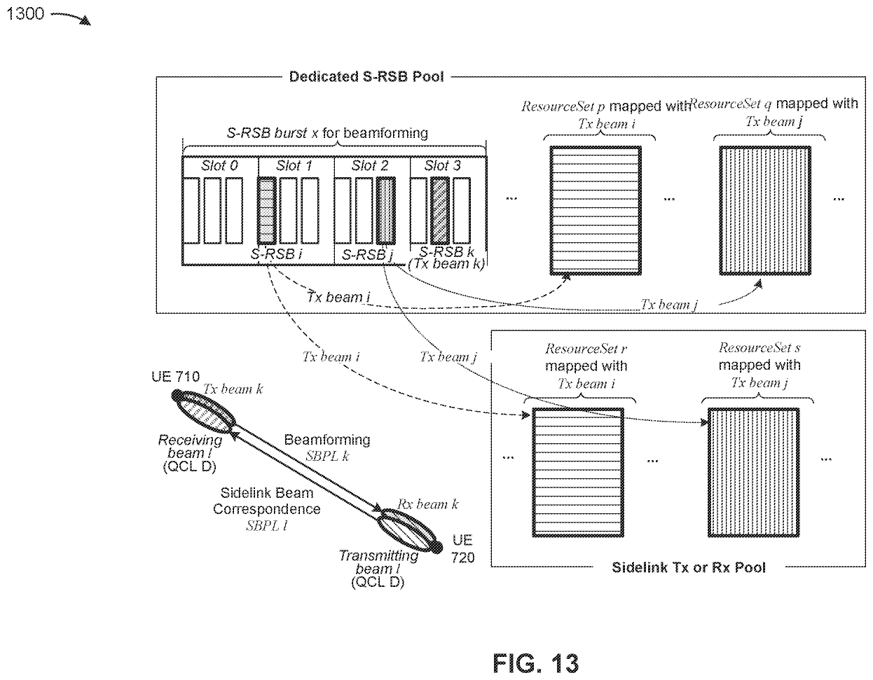

FIG. 13 is a diagram illustrating an example 1300 of resources associated with beams, in accordance with the present disclosure.

In some aspects, a sidelink beam management block, such as an S-RSB (e.g., associated with a Tx beam) of an S-RSB burst sweeping with different S-RSBs (e.g., different Tx beams) from a first UE (e.g., UE 710), may be associated with a resource set and Rx beam at a second UE (e.g., UE 720) (e.g., beam pairing between a Tx beam and a Rx beam). Therefore, sidelink resources may be mapped accordingly for sidelink communication from a second UE (e.g., UE 720). For example, a Tx beam may be associated with an S-RSB of a beamforming S-RSB burst (e.g., Tx beam i or Tx beam j of S-RSB burst x) transmitted by a first UE (e.g., UE 710) and selected by a second UE (e.g., UE 720). There may be a resource set associated with or mapped in the dedicated S-RSB pool (e.g., ResourceSet p mapped with Tx beam i and an Rx beam paired therewith or Resource Set q mapped with Tx beam j and an Rx beam paired therewith) and/or a sidelink transmitting or receiving pool (e.g., Resource Set r mapped with Tx beam i and an Rx beam paired therewith or Resource Sets mapped with Tx beam j and an Rx beam paired therewith) for sidelink communication messages (e.g., discovery, DCR, or beam report message) from the second UE to the first UE after beamforming with a sidelink beam pair link (e.g., SBPL k, which is formed with the selected Tx beam from the first UE and the paired Rx beam at the second UE. The resource set association or mapping may be specified, preconfigured, configured (e.g., common or dedicated RRC configuration), activated (e.g., MAC CE) (e.g., based at least in part on the ID or index of the selected Tx beam or the index of the S-RSB or the resource indication of S-RSB associated with the selected Tx beam), or indicated by the SCI part 2 with preferred resources of the S-RSB associated to the selected Tx beam.

In some aspects, sidelink beam correspondence may be enabled based at least in part on a UE's capability. A Tx beam from a first UE (e.g., UE 710) may be associated with an S-RSB of a beamforming S-RSB burst (e.g., S-RSB k associated with Tx beam k of S-RSB burst x) transmitted by the first UE and selected by a second UE (e.g., UE 720) with an Rx beam via beamforming with a first sidelink beam pair link (e.g., SBPL k is formed with Tx beam k and Rx beam k). There is a receiving beam (e.g., the receiving beam 1) for the first UE to monitor sidelink communication message(s) (e.g., discovery, DCR, or beam report message) from the second UE. In some aspects, the receiving beam (e.g., receiving beam 1) corresponding to Tx beam (e.g., Tx beam k) at the first UE, for example, based on QCL Type-D (same spatial filter) between a first RS of the S-RSB associated to the selected Tx beam (e.g., S-RSB k with Tx beam k) from the first UE and a second RS of the S-RSB from the second UE (not shown) associated with the transmitting beam (e.g., the transmitting beam 1) for the second UE to transmit sidelink communication message(s) to the first UE (e.g., the transmitting beam 1 corresponding to Rx beam k at the second UE, for example, based on QCL Type-D). The transmitting beam and the receiving beam may form a second sidelink beam pair link (e.g., SBPL 1 is formed with transmitting beam 1 and receiving beam 1) based at least in part on the sidelink beam correspondence.

As indicated above, FIG. 13 is provided as an example. Other examples may differ from what is described with regard to FIG. 13.

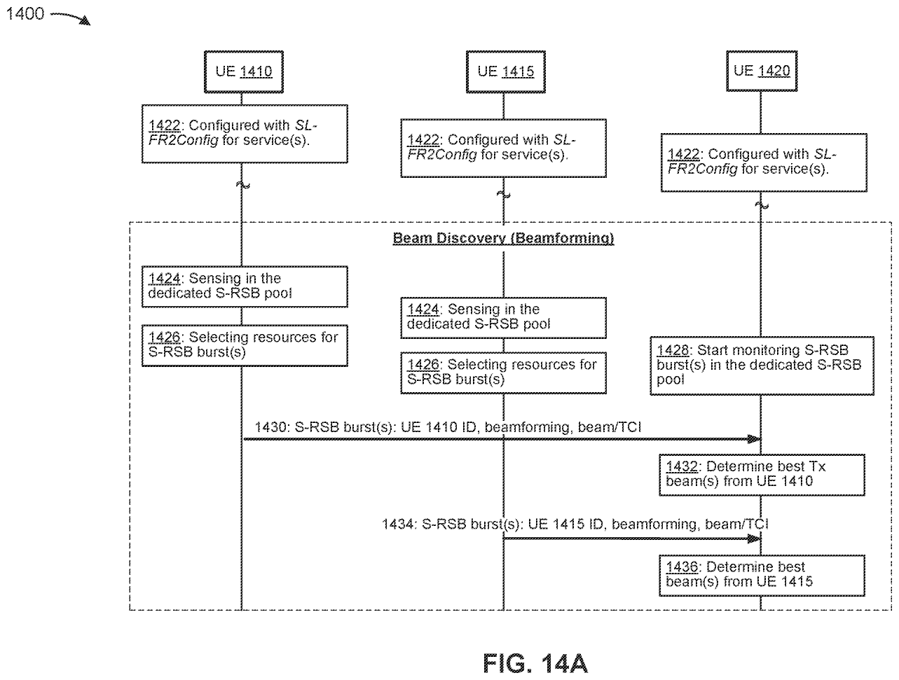

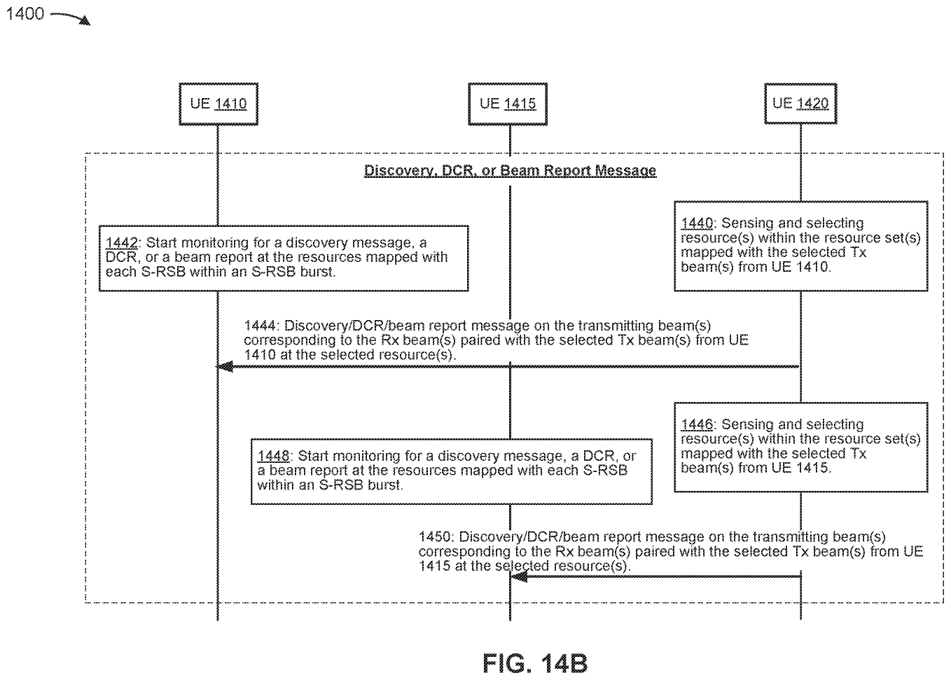

FIGS. 14A and 14B are diagrams illustrating an example 1400 of S-RSB beam sweeping, in accordance with the present disclosure. A first Tx UE 1410 and a second Tx UE 1415 may communicate with an Rx UE 1420 on a sidelink channel.

FIG. 14A shows the UEs performing a beam discovery or beamforming operation on a sidelink. As shown by reference number 1422, UE 1410, UE 1415, and UE 1420 may be configured with an FR2 configuration for one or more services. The UEs may be configured (by signaling or stored preconfigured information) with parameters related to FR2 operations (e.g., SL-FR2Config) with an FR2 frequency list and associated one or more numerologies for one or more sidelink BWPs respectively. The UEs may be configured with a dedicated sidelink beam management block resource pool (e.g., S-RSB resource pool) and transmitting and/or receiving resource pools for each sidelink BWP. The UEs may be configured with S-RSB burst parameters, such as a burst duration, a burst period, a burst offset, a burst offset slot, a quantity of S-RSBs of an S-RSB burst, an S-RSB interval, and/or an S-RSB structure per the numerology of the dedicated-RSB resource pool. The UEs may be configured with the resource set association or mapping with each Tx beam or S-RSB of an S-RSB burst in the dedicated resource pool or shared transmitting and/or receiving pools for sidelink communications.

The UEs may be part of a beam discovery or beamforming operation. As shown by reference number 1424, UE 1410 and UE 1415 may be sensing in a dedicated S-RSB resource pool. UE 1410 and UE 1415 may perform sensing in the dedicated S-RSB resource pool based at least in part on decoding the SCI indicating resources reserved for S-RSB transmission(s) and/or sidelink RSRP, RSRQ, or SINR measurement (e.g., resource reservation for an S-RSB in the nest S-RSB burst based at least in part on the S-RSB burst duration and S-RSB period).

As shown by reference number 1426, UE 1410 and UE 1415 may select one or more resources for one or more S-RSB bursts based at least in part on the sensing. As shown by reference number 1428, UE 1420 may start monitoring for S-RSB burst(s) in the dedicated S-RSB resource pool.

As shown by reference number 1430, UE 1410 may transmit one or more S-RSB bursts with a source ID (e.g., UE 1410 ID), and/or a destination ID (e.g., UE 1420 ID or service ID or sidelink communication ID for a unicast between UE 1410 and UE 1420), a beamforming indication, a beam index, a beam ID, a spatial filter or TCI, an S-RSB index or S-RSB resource indication, an S-RSB burst configuration index, or other information indicated in each S-RSB transmission. As shown by reference number 1432, UE 1420 may determine one or more selected Tx beams from UE 1410 based at least in part on measurements (e.g., sidelink RSRP, sidelink RSRQ, or sidelink SINR), a beamforming indication, a beam index or ID, and/or a spatial filter or TCI indicated in the received S-RSB associated with the one or more selected Tx beams from UE 1410.

As shown by reference number 1434, UE 1415 may transmit one or more S-RSB bursts with a source ID (e.g., UE 1415 ID) and/or a destination ID (e.g., UE 1420 ID or service ID or sidelink communication ID for a unicast between UE 1415 and UE 1420), a beamforming indication, a beam index, a beam ID, a spatial filter or TCI, an S-RSB index or S-RSB resource indication, an S-RSB burst configuration index, or other information indicated in each S-RSB transmission. As shown by reference number 1436, UE 1420 may determine one or more selected Tx beams from UE 1410 based at least in part on measurements (e.g., sidelink RSRP, sidelink RSRQ, or sidelink SINR) and the beamforming indication, a beam index or ID, and/or a spatial filter or TCI indicated in the received S-RSB associated with the one or more selected Tx beams from UE 1415.

In some aspects, UE 1420 may transmit a sidelink communication with peer discovery, DCR, or beam report message, as shown by the continuation of example 1400 in FIG. 14B. As shown by reference number 1440, UE 1420 may perform sensing and resource selection (e.g., using the Rx beam paired with the selected Tx beam during beamforming) within the resource set mapped to the S-RSB associated with a selected Tx beam from UE 1410 (e.g., identified by the source ID (the Tx UE) or the destination ID (the service or sidelink communication) in the S-RSB associated with the selected Tx beam). UE 1420 may perform resource selection based at least in part on the S-RSB index or S-RSB resource indication, the Tx beam ID, or the Tx beam index. The resource selection may be within the preferred resources indicated in the S-RSB associated with a selected Tx beam from UE 1410. As shown by reference number 1442, UE 1410 may start monitoring for a sidelink communication with a discovery message, a DCR, or a beam report at the resource sets respectively mapped with each S-RSB or Tx beam within its S-RSB burst. UE 1410 may use the receiving beams respectively corresponding to each S-RSB or Tx beam within its S-RSB burst based at least in part on sidelink beam correspondence. As shown by reference number 1444, UE 1420 may transmit to UE 1410 a sidelink communication with a discovery message, a DCR, or a beam report on the transmitting beam(s) corresponding respectively with the Rx beams paired with the selected Tx beam(s) from UE 1410 at the selected resources within the resource set.

As shown by reference number 1446, UE 1420 may perform sensing and resource selection (e.g., using the Rx beam paired with the selected Tx beam during beamforming) within the resource set mapped to the S-RSB associated with a selected Tx beam from UE 1415 (e.g., identified by the source ID (the Tx UE) or the destination ID (the service or sidelink communication) in the S-RSB associated with the selected Tx beam). The selection may be based at least in part on the S-RSB index or S-RSB resource indication, the Tx beam ID, or Tx beam index and/or within the preferred resources indicated in the S-RSB associated with a selected Tx beam from UE 1415. As shown by reference number 1448, UE 1415 may start monitoring for a sidelink communication with a discovery message, a DCR, or a beam report at the resource sets respectively mapped with each S-RSB or Tx beam within its S-RSB burst. UE 1415 may use the receiving beams respectively corresponding to each S-RSB or Tx beam within its S-RSB burst based at least in part on sidelink beam correspondence.

As shown by reference number 1450, UE 1420 may transmit to UE 1415 a sidelink communication with a discovery message, a DCR, or beam report on one or more transmitting beams associated with the one or more Rx beams paired with the one or more selected Tx beams from UE 1415 at the selected resources within the one or more resource sets. UE 1420 may transmit on the one or more transmitting beams based at least in part on beam correspondence respectively with the one or more Rx beams paired with the one or more selected Tx beams. The sidelink beam correspondence may include beam information provided by S-RSBs of an S-RSB burst.

As indicated above, FIGS. 14A-14B are provided as an example. Other examples may differ from what is described with regard to FIGS. 14A-14B.

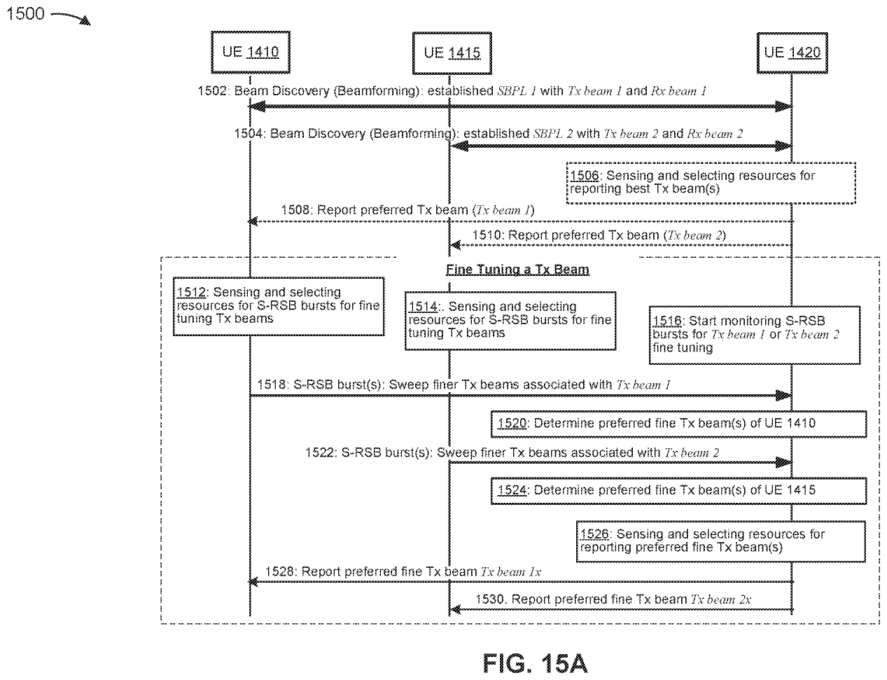

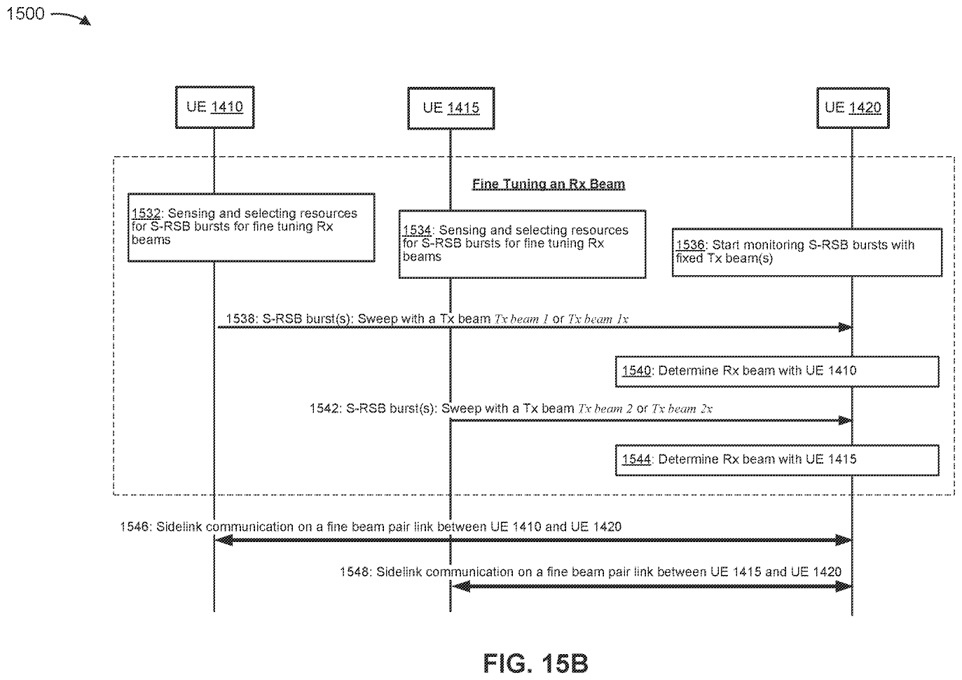

FIGS. 15A and 15B are diagrams illustrating an example 1500 of S-RSB beam sweeping for beam fine tuning, in accordance with the present disclosure.

FIG. 15A shows beam fine tuning for a transmitting beam. As shown by reference numbers 1502, UE 1410 may establish a sidelink beam pair link (SBPL), such as SBPL 1 with UE 1420 using beam discovery or beamforming operation described in FIG. 14A. SBPL 1 may be with Tx beam 1 and Rx beam 1 paired. As shown by reference numbers 1504, UE 1415 may establish an SBPL with UE 1420 also using beam discovery or a beamforming operation described in FIG. 14A. SBPL2 may be with Tx beam 2 and Rx beam 2 paired.

As shown by reference number 1506, UE 1420 may optionally, after beam pairing or beamforming, perform sensing and select resources in the dedicated sidelink beam management block pool (e.g., S-RSB resource pool) or UE 1420's transmit resource pool, based at least in part on the resource set mapped with the S-RSB associated with the selected Tx beam (e.g., Tx beam 1) from UE 1410 or on the resource set mapped with the selected Tx beam (e.g., Tx beam 2) from UE 1415 or the preferred resources indicated in the S-RSB associated with the selected Tx beam (e.g., Tx beam 1) from UE 1410 or the preferred resources indicated in the S-RSB associated with the selected Tx beam (e.g., Tx beam 2) from UE 1413. As shown by reference number 1508, UE 1420 may report one or more selected Tx beams from UE 1410 (e.g., Tx beam 1 as shown, optionally including the paired Rx beam). As shown by reference number 1510, UE 1420 may report one or more selected Tx beams from UE 1415 (e.g., Tx beam 2 as shown, optionally including the paired Rx beam).

In some aspects, UE 1420 may report the selected (e.g., greatest RSRP, RSSI, or SINR) Tx beam(s) to each Tx UE at the selected resources (e.g., report Tx beam 1 to UE 1410 and report Tx beam 2 to UE 1415, optionally including the paired Rx beam) using a transmitting beam corresponding to an Rx beam of UE 1420. The Rx beam may be paired with the selected Tx beam of each Tx UE during the beamforming (e.g., based at least in part on beam correspondence or QCL Type-D, if supported). Additionally, the beam report may be indicated via a PC5 RRC message or a PC5 MAC CE or SCI part 2. The beam report may indicate the beam ID or index, an associated S-RSB index or S-RSB resource indication, and/or a spatial filter or TCI, as included in the received SCI transmitted with the S-RSB associated with the selected Tx beam. UE 1410 and UE 1415 may monitor for possible transmissions from UE 1420 at a resource set in the dedicated S-RSB resource pool or a receiving resource pool of UE 1410 or UE 1415 based at least in part on the resource mapping with each Tx beam or each S-RSB of its S-RSB burst(s) or the preferred resources indicated in each S-RSB of its S-RSB burst(s). UE 1420 may transmit a communication to UE 1410 or UE 1415 using a transmitting beam corresponding to the Rx beam paired with the selected Tx beam from UE 1410 or UE 1415 (e.g., based at least in part on beam correspondence or QCL Type-D, if supported).

As shown by reference number 1512, UE 1410 may sense and select resources for S-RSB bursts for beam fine tuning Tx beams. The resource selection may be based at least in part on an S-RSB burst association (e.g., as described with details in FIG. 11) specified or preconfigured or configured or activated, or a resource set mapped with the S-RSB associated with the selected Tx beam that is reported to UE 1410 (e.g., selected Tx beam Tx beam 1 reported to UE 1410), or the preferred resources indicated in the S-RSB associated with the selected Tx beam that is reported to UE 1410. As shown by reference number 1514, UE 1415 may sense and select resources for S-RSB bursts for beam fine tuning Tx beams. The resource selection for UE 1415 may be similar to the resource selection described for UE 1410.

As shown by reference number 1516, UE 1420 may start monitoring for S-RSB bursts for Tx beam 1 or Tx beam 2 fine tuning. For example, the monitoring may be based at least in part on the S-RSB burst association (e.g., as described in connection with FIG. 11) specified, preconfigured, configured, or activated. The monitoring may be based at least in part on the resource set mapped with the S-RSB that is associated with the selected Tx beam that is reported (e.g., selected Tx beam Tx beam 1 reported to UE 1410 and selected Tx beam Tx beam 2 reported to UE 1415) or the preferred resources indicated in the S-RSB associated with the selected Tx beam that is reported to UE 1410 or UE 1415.

As shown by reference number 1518, UE 1410 may transmit one or more S-RSB bursts to sweep Tx fine beams associated with the reported Tx beam Tx beam 1. As shown by reference number 1520, UE 1420 may select a Tx fine beam of UE 1410. As shown by reference number 1522, UE 1415 may transmit one or more S-RSB bursts to sweep Tx fine beams associated with the reported Tx beam Tx beam 2. As shown by reference number 1524, UE 1420 may select a Tx fine beam of UE 1415. UE 1410 and UE 1415 may transmit the S-RSB bursts for Tx beam fine tuning with source IDs (e.g., identifying UE 1410 and UE1415), a beam fine tuning of Tx beams indication, a Tx fine beam index or ID, a spatial filter or TCI, an S-RSB index or S-RSB resource indication, and/or an S-RSB burst configuration index, as indicated in each S-RSB transmission during the S-RSB bursts for Tx beam fine tuning.

As shown by reference number 1526, UE 1420 may sense and select resources for reporting selected Tx fine beams. For example, UE 1420 may determine one or more selected Tx beams from UE 1410 and UE 1415 based at least in part on the measurements (e.g., RSRP, RSRQ, or SINR), the beam fine tuning if Tx beams indication, a Tx fine beam index or ID, and/or a spatial filter or TCI indicated in the received S-RSB associated with the selected Tx fine beams from UE 1410 and UE 1415 during the one or more S-RSB bursts for Tx beam fine tuning. UE 1420 may then perform sensing and select resources in the dedicated S-RSB resource pool or a transmitting resource pool of UE 1420, based at least in part on the resource set mapped with the S-RSB associated with the selected Tx fine beam or the preferred resources indicated in the S-RSB associated with the selected Tx fine beam, for reporting selected Tx fine beams from UE 1410 and UE 1415.

As shown by reference number 1528, UE 1420 may report the selected Tx fine beam Tx beam 1x to UE 1410. As shown by reference number 1530, UE 1420 may report the selected Tx fine beam Tx beam 2x to UE 1415. UE 1420 may report Tx beam 1x and Tx beam 2x (optionally including the paired Rx beam) at the selected resources using a fine transmitting beam corresponding to a Rx beam of UE 1420 (e.g., based at least in part on beam correspondence or QCL Type-D, if supported). The Rx beam may be paired with the selected Tx fine beam of UE 1410 or UE 1415 during the Tx beam fine tuning. Additionally, the report may be indicated via a PC5 RRC message or a PC5 MAC CE or SCI part 2 (e.g., indicating the Tx fine beam ID or index, the associated S-RSB index or S-RSB resource indication, the spatial filter or TCI as included in the received S-RSB that is associated with the selected Tx fine beam). UE 1410 and UE 1415 may monitor for possible transmissions from UE 1420 at a resource set in the dedicated S-RSB resource pool or a receiving resource pool of UE 1410 and UE 1415, based at least in part on the resource mapping with each S-RSB of its S-RSB burst(s) for Tx beam fine tuning or the preferred resources indicated in each S-RSB of its S-RSB burst(s) for Tx beam fine tuning. The monitoring may use the fine receiving beam corresponding to the Tx fine beam associated with each S-RSB of its S-RSB burst(s) for Tx beam fine tuning (e.g., based at least in part on beam correspondence or QCL Type-D, if supported).

FIG. 15B shows beam fine tuning for a receiving beam. Similar to FIG. 15A for beam fine tuning for a Rx beam, UE 1410 may perform sensing and select resources in the dedicated S-RSB resource pool, as shown by reference number 1532, and UE 1415 may perform sensing and select resources in the dedicated S-RSB resource pool, as shown by reference number 1534. The resource selections may be based at least in part on the S-RSB burst association (e.g., as described in connection with FIG. 11), the resource set mapped to the S-RSB that is associated with the selected Tx beam that is reported (e.g., selected Tx beam Tx beam 1 reported to UE 1410 and selected Tx beam Tx beam 2 reported to UE 1415), the selected Tx fine beam that is reported (e.g., selected Tx Beam 1x reported to UE 1410 and selected Tx Beam 2x reported to UE 1415), and/or the preferred resources indicated in the S-RSB that is associated with the selected Tx beam that is reported or the selected Tx fine beam that is reported.

As shown by reference number 1536, UE 1420 may start monitoring for S-RSB bursts with a fixed Tx beam. For example, the monitoring may be for one or more S-RSB bursts for Rx beam fine tuning (e.g., S-RSB bursts with fixed Tx beam such as Tx beam 1 or Tx beam 1x from UE 1410 or Tx beam 2 or Tx beam 2x from UE 1415). The monitoring may be based at least in part on the S-RSB burst association (e.g., as described in connection with FIG. 11), the resource set mapped with the S-RSB that is associated with the selected Tx beam that is reported (e.g., selected Tx beam 1 reported to UE 1410 and selected Tx beam 2 reported to UE 1415), the selected Tx fine beam that is reported (e.g., selected Tx beam 1x reported to UE 1410, and selected Tx beam 2x reported to UE 1415), and/or the preferred resources indicated in the S-RSB associated with the selected Tx beam that is reported or the selected Tx fine beam that is reported.

As shown by reference number 1538, UE 1410 may transmit one or more S-RSB bursts that sweep with a Tx beam (e.g., Tx beam 1 or Tx beam 1x). As shown by reference number 1540, UE 1420 may select an Rx beam paired with UE 1410's Tx beam or Tx fine beam. As shown by reference number 1542, UE 1415 may transmit one or more S-RSB bursts that sweep with a Tx beam (e.g., Tx beam 2 or Tx beam 2x). As shown by reference number 1544, UE 1420 may determine select an Rx beam paired with UE 1415's Tx beam or Tx fine beam. UE 1410 and UE 1415 may each transmit the S-RSB bursts for Rx beam fine tuning with a source ID, a beam fine tuning of Rx beams indication, a fixed Tx beam or Tx fine beam index or ID, a spatial filter or TCI, an S-RSB index or S-RSB resource indication, and/or an S-RSB burst configuration index indicated in each S-RSB transmission during the S-RSB bursts for Rx beam fine tuning. UE 1420 may sweep with Rx fine beams associated with a Rx beam paired with the selected Tx beam during beamforming with UE 1410 and UE 1415 (e.g., Rx beam 1 with UE 1410 or Rx beam 2 with Tx UE 1415) or an Rx beam corresponding to the selected Tx fine beam (e.g., based at least in part on sidelink beam correspondence) during Tx beam fine tuning with UE 1410 and UE 1415 (e.g., Tx beam 1x with UE 1410 or Tx beam 2x with UE 1415). UE 1420 may determine one or more Rx fine beams based at least in part on the beam measurements (e.g., RSRP, RSRQ, SINR), a beam fine tuning of Rx beams indication, a Tx beam or Tx fine beam index or ID, and/or a spatial filter or TCI indicated in each S-RSB associated with the selected Tx beam or the selected Tx fine beam from UE 1410 and UE 1415 respectively.

UE 1410 and/or UE 1415 may exchange sidelink communications (e.g., a sidelink message with peer discovery, a DCR, a beam report, or a sidelink data packet) with UE 1420 with corresponding fine-tuned Tx and/or Rx beams. As shown by reference number 1546, UE 1410 may exchange sidelink communications on a fine sidelink beam pair link between UE 1410 and UE 1420. As shown by reference number 1548, UE 1415 may exchange sidelink communications on a fine sidelink beam pair link between UE 1415 and UE 1420.

In some aspects, Tx beam or Rx beam fine tuning may be based at least in part on the association (in time sequence) between S-RSB burst(s) for beam forming and S-RSB burst(s) for Tx or Rx beam fine tuning (e.g., as the S-RSB burst association illustrated in FIG. 11). A first S-RSB burst for beam forming is followed by a second S-RSB burst for Tx beam fine tuning or Rx beam fine tuning. A UE may establish a fine-tuned sidelink beam pair link via this association (in time sequence) between S-RSB burst(s) for beam forming and S-RSB burst(s) for Tx beam fine tuning and Rx beam fine tuning, which may be specified, preconfigured, configured, or activated. In this case, an S-RSB burst(s) for fine tuning Tx beam or Rx beam may be shared by one or more UEs monitoring the S-RSB burst(s) for fine tuning Tx beam or Rx beam, and therefore only source ID or destination ID (e.g., source ID identifying the UE transmitting S-RSB burst(s) or a destination ID identifying a service or sidelink communication in which one or more UEs participated) may be indicated in the S-RSB for identifying a UE sending the S-RSB burst for beam fine tuning.

In some aspects, Tx beam or Rx beam fine tuning may be triggered by one of the paired UEs, for example, based at least in part on the beam measurements or a beam report. The UE 1420 may trigger a Tx beam fine tuning or Rx beam fine tuning based at least in part on the beam measurements and then send the Tx or Rx fine tuning request with its beam report. UE 1410 or UE 1415 may determine a Tx beam fine tuning or Rx beam fine tuning based at least in part on the beam report that is received. In this case, an S-RSB burst(s) for fine tuning Tx beam or Rx beam may be dedicated to paired UEs (e.g., dedicated to UE 1410 and UE 1420 or UE 1415 and UE 1420) for the triggered Tx or Rx fine tuning, and therefore both the source ID (e.g., identify UE 1410 or UE 1415) and the destination ID (e.g., identifying UE 1420) may be indicated in the S-RSB for identifying a UE sending the triggered S-RSB burst for Tx or Rx beam fine tuning and identifying a UE monitoring the triggered S-RSB burst for Tx or Rx beam fine tuning. The dedicated Tx and Rx fine tuning are described in details in FIG. 15A and FIG. 15B respectively.

By using S-RSB s in beam sweep patterns for beamforming, beam fine tuning, and beam pairing, among other sidelink beam management operations, sidelink UEs may conserve power and signaling resources while reducing latency and interference.

As indicated above, FIGS. 15A-15B are provided as an example. Other examples may differ from what is described with regard to FIGS. 15A-15B.

As illustrated above, a first UE (e.g., UE 710 in FIGS. 7-10 and 13, or UE 1410 or UE 1415 in FIGS. 14A-15B) may transmit one or more sidelink beam management block bursts (e.g., S-RSB bursts) with Tx beam(s) for beamforming or Tx or Rx beam fine tuning. A second UE (e.g., UE 720 in FIGS. 7-10 and 13, or UE 1420 in FIGS. 14A-15B) may monitor the one or more sidelink beam management block bursts (e.g., S-RSB bursts) to select a Tx beam to pair with its Rx beam or fine tune Tx or Rx beam for a sidelink beam pair link for the sidelink communication at least from the first UE as a Tx UE to the second UE as an Rx UE. For the reversed direction sidelink communication from the second UE as a Tx UE and the first UE as an Rx UE, sidelink beam correspondence may be applied for the second UE to determine a transmitting beam and for the first UE to determine a receiving beam (without beam forming or fine tuning), for UEs supporting sidelink beam correspondence (e.g., indicated by UE capability, for example, during the time of establishing PC5 RRC connection or unicast connection between the first and second UE).

However, for UEs not capable of supporting sidelink beam correspondence (e.g., not indicated by UE capability, for example, during the time of establishing PC5 RRC connection or unicast connection between the first and second UE), the second UE may transmit S-RSB burst(s) for beamforming or Tx or Rx fine tuning. The first UE may monitor the S-RSB burst(s), select the Tx beam from the second UE, and pair its Rx beam(s) respectively with the selected Tx beams from the second UE. The first UE may fine tune the Tx beam or Rx beam and then report the selected Tx beam(s) and/or Rx beams to the second UE. That is, the sidelink beam pair link for the reversed direction of sidelink communication (e.g., from the second UE to the first UE) may be established via the reversed direction beam forming or Tx or Rx beam fine tuning (e.g., not based on sidelink beam correspondence). In this case, the sidelink beam pair link from the first UE to the second UE may not be the same (e.g., not spatially symmetric or not with QCL type D) as the sidelink beam pair link from the second UE to the first UE. FIG. 16 is a diagram illustrating an example process 1600 performed, for example, by a UE or an apparatus of the UE, in accordance with the present disclosure. Example process 1600 is an example where the UE (e.g., UE 120, UE 1410, UE 1415) performs operations associated with reference signal blocks for sidelink.

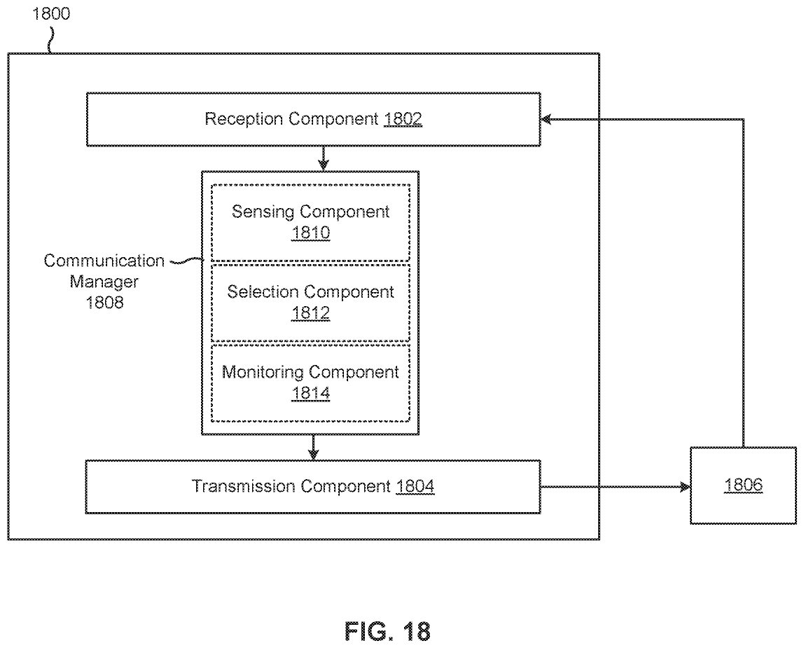

As shown in FIG. 16, in some aspects, process 1600 may include performing sensing in a sidelink resource pool (block 1610). For example, the UE (e.g., using communication manager 1808 and/or sensing component 1810 depicted in FIG. 18) may perform sensing in a sidelink resource pool, as described above.

As further shown in FIG. 16, in some aspects, process 1600 may include selecting, based at least in part on the sensing, one or more sidelink resources for one or more sidelink beam management blocks (e.g., S-RSBs), where each sidelink beam management block (e.g., S-RSB) includes at least one beam management signal (e.g., RS) and/or SCI (block 1620). For example, the UE (e.g., using communication manager 1808 and/or selection component 1812 depicted in FIG. 18) may select, based at least in part on the sensing, one or more sidelink resources for one or more sidelink beam management blocks (e.g., S-RSBs), where each sidelink beam management block (e.g., S-RSB) includes at least one beam management signal (e.g., RS) and/or SCI, as described above.

As further shown in FIG. 16, in some aspects, process 1600 may include transmitting the one or more sidelink beam management blocks in a sidelink beam management block burst (e.g., S-RSBs in an S-RSB burst) using the one or more sidelink resources (block 1630). For example, the UE (e.g., using communication manager 1808 and/or transmission component 1804 depicted in FIG. 18) may transmit the one or more sidelink beam management blocks in a sidelink beam management block burst (e.g., S-RSBs in an S-RSB burst) using the one or more sidelink resources, as described above.

Process 1600 may include additional aspects, such as any single aspect or any combination of aspects described below and/or in connection with one or more other processes described elsewhere herein.

In a first aspect, the sidelink resource pool is a resource pool for sidelink beam management.

In a second aspect, alone or in combination with the first aspect, the S-RSB burst includes a quantity of S-RSBs within the S-RSB burst, has a specified duration, uses a time period for transmission of the S-RSB burst, and/or uses an offset for starting the S-RSB burst.

In a third aspect, alone or in combination with one or more of the first and second aspects, the SCI indicates a time interval for resource reservation based at least in part on a time period for transmission of the S-RSB burst.

In a fourth aspect, alone or in combination with one or more of the first through third aspects, the SCI indicates one or more time and frequency resources reserved for one or more S-RSB transmissions respectively in one or more S-RSB bursts.

In a fifth aspect, alone or in combination with one or more of the first through fourth aspects, the SCI indicates an S-RSB index of an S-RSB within the S-RSB burst.

In a sixth aspect, alone or in combination with one or more of the first through fifth aspects, the SCI indicates a TCI state or a spatial filter of a beam used to transmit the S-RSB.

In a seventh aspect, alone or in combination with one or more of the first through sixth aspects, the SCI indicates an ID or an index of a beam used to transmit the S-RSB.

In an eighth aspect, alone or in combination with one or more of the first through seventh aspects, the SCI includes a source identifier.

In a ninth aspect, alone or in combination with one or more of the first through eighth aspects, the SCI indicates a beam management operation, where the beam management operation includes beamforming, beam fine tuning, or beam measurement.

In a tenth aspect, alone or in combination with one or more of the first through ninth aspects, the SCI is an SCI part 1, and the S-RSB includes SCI part 2 that indicates one or more of a source ID or a destination ID.

In an eleventh aspect, alone or in combination with one or more of the first through tenth aspects, the SCI is an SCI part 1, and the S-RSB includes SCI part 2 that indicates preferred resources or non-preferred resources associated with the S-RSB.

In a twelfth aspect, alone or in combination with one or more of the first through eleventh aspects, the at least one RS includes a first RS used for AGC.

In a thirteenth aspect, alone or in combination with one or more of the first through twelfth aspects, the at least one RS includes a second RS for beamforming, beam fine tuning, or beam measurements.

In a fourteenth aspect, alone or in combination with one or more of the first through thirteenth aspects, process 1600 includes monitoring for a sidelink communication based at least in part on each S-RSB of the one or more S-RSBs in the S-RSB burst, and receiving the sidelink communication.

In a fifteenth aspect, alone or in combination with one or more of the first through fourteenth aspects, monitoring for the sidelink communication includes monitoring for the sidelink communication in one or more resource sets based at least in part on one or more of a configured time duration after each S-RSB of the one or more S-RSBs in the S-RSB burst, a mapping of each resource set of the one or more resource sets with a respective S-RSB of the one or more S-RSBs in the S-RSB burst, or SCI part 2 included in each S-RSB of the one or more S-RSBs in the S-RSB burst.

In a sixteenth aspect, alone or in combination with one or more of the first through fifteenth aspects, monitoring for the sidelink communication includes monitoring for the sidelink communication using one or more receiving beams that are based at least in part on one or more respective transmitting beams that are associated with each S-RSB of the one or more S-RSBs in the S-RSB burst.

In a seventeenth aspect, alone or in combination with one or more of the first through sixteenth aspects, the sidelink communication includes a discovery message, a DCR, or a beam report.

In an eighteenth aspect, alone or in combination with one or more of the first through seventeenth aspects, transmitting the one or more S-RSBs in the S-RSB burst includes transmitting the one or more S-RSBs in a first beam sweeping pattern.

In a nineteenth aspect, alone or in combination with one or more of the first through eighteenth aspects, process 1600 includes transmitting S-RSBs in a second beam sweeping pattern.

In a twentieth aspect, alone or in combination with one or more of the first through nineteenth aspects, process 1600 includes receiving an indication of a selected beam associated with the second beam sweeping pattern.

In a twenty-first aspect, alone or in combination with one or more of the first through twentieth aspects, the first beam sweeping pattern is for beamforming, and an S-RSB of the first beam sweeping pattern is mapped to a second beam sweeping pattern for beam fine tuning.

In a twenty-second aspect, alone or in combination with one or more of the first through twenty-first aspects, transmitting the one or more S-RSBs in the S-RSB burst includes transmitting repetitions of an S-RSB.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, by a UE or an apparatus of a UE, in accordance with the present disclosure. Example process 1700 is an example where the UE (e.g., UE 120, UE 1420) performs operations associated with reference signal blocks for sidelink.

As shown in FIG. 17, in some aspects, process 1700 may include monitoring for one or more sidelink beam management blocks in a sidelink beam management block burst (e.g., S-RSBs in an S-RSB burst) in a sidelink resource pool (block 1710). For example, the UE (e.g., using communication manager 1808 and/or monitoring component 1814 depicted in FIG. 18) may monitor for one or more sidelink beam management blocks in a sidelink beam management block burst (e.g., S-RSB s in an S-RSB burst) in a sidelink resource pool, as described above.

As further shown in FIG. 17, in some aspects, process 1700 may include receiving the one or more sidelink beam management blocks in the sidelink beam management block burst (e.g., S-RSB s in the S-RSB burst), where each sidelink beam management block in the sidelink beam management block burst (e.g., S-RSB in the S-RSB burst) includes at least one beam management signal (e.g., RS) and/or SCI (block 1720). For example, the UE (e.g., using communication manager 1808 and/or reception component 1802 depicted in FIG. 18) may receive the one or more sidelink beam management blocks in the sidelink beam management block burst (e.g., S-RSB s in the S-RSB burst), where each sidelink beam management block in the sidelink beam management block burst (e.g., S-RSB in the S-RSB burst) includes at least one beam management signal (e.g., RS) and/or SCI, as described above.

As further shown in FIG. 17, in some aspects, process 1700 may include selecting a beam based at least in part on the one or more sidelink beam management blocks in the sidelink beam management block burst (e.g., S-RSB s in the S-RSB burst) (block 1730). For example, the UE (e.g., using communication manager 1808 and/or selection component 1812 depicted in FIG. 18) may select a beam based at least in part on the one or more sidelink beam management blocks in the sidelink beam management block burst (e.g., S-RSBs in the S-RSB burst), as described above.

Process 1700 may include additional aspects, such as any single aspect or any combination of aspects described below and/or in connection with one or more other processes described elsewhere herein.

In a first aspect, process 1700 includes performing sensing for a sidelink communication, selecting a resource for the sidelink communication based at least in part on the selected beam, and transmitting the sidelink communication. In some aspects, the sensing may be performed in the sidelink resource pool.

In a second aspect, in combination with the first aspect, selecting the resource includes selecting the resource from a resource set based at least in part one or more of a configured time duration after each S-RSB of the one or more S-RSBs in the S-RSB burst, a mapping of the resource set with an S-RSB of the one or more S-RSBs in the S-RSB burst, or SCI part 2 included in each S-RSB of the one or more S-RSBs in the S-RSB burst.

In a third aspect, in combination with one or more of the first and second aspects, transmitting the sidelink communication includes transmitting the sidelink communication using a transmitting beam that is associated with the selected beam.

In a fourth aspect, in combination with one or more of the first through third aspects, the sidelink communication includes a discovery message, a DCR, or a beam report.

In a fifth aspect, alone or in combination with one or more of the first through fourth aspects, the SCI indicates one or more time and frequency resources reserved for one or more S-RSB transmissions respectively in one or more S-RSB bursts.

In a sixth aspect, alone or in combination with one or more of the first through fifth aspects, the SCI indicates an S-RSB index of the S-RSB within the S-RSB burst.

In a seventh aspect, alone or in combination with one or more of the first through sixth aspects, the SCI indicates a TCI state or a spatial filter of a beam used to transmit the S-RSB.

In an eighth aspect, alone or in combination with one or more of the first through seventh aspects, the SCI indicates an identifier or an index of a beam used to transmit the S-RSB.

In a ninth aspect, alone or in combination with one or more of the first through eighth aspects, the SCI includes a source identifier.

In a tenth aspect, alone or in combination with one or more of the first through ninth aspects, the SCI indicates a beam management operation, and selecting the beam includes selecting the beam based at least in part on the beam management operation.

In an eleventh aspect, alone or in combination with one or more of the first through tenth aspects, the SCI is an SCI part 1, and the S-RSB includes SCI part 2 that indicates one or more of a source ID or a destination ID.

In a twelfth aspect, alone or in combination with one or more of the first through eleventh aspects, the SCI is an SCI part 1, and the S-RSB includes SCI part 2 that indicates preferred resources or non-preferred resources associated with the S-RSB.

In a thirteenth aspect, alone or in combination with one or more of the first through twelfth aspects, the at least one RS includes a first RS used for automatic gain control.

In a fourteenth aspect, in combination with the thirteenth aspect alone or in further combination with one or more of the first through twelfth aspects, the at least one RS includes a second RS for beam forming, fine tuning, or beam measurements.

In a fifteenth aspect, alone or in combination with one or more of the first through fourteenth aspects, selecting the beam includes selecting the beam based at least in part on measurements of the one or more S-RSBs in the S-RSB burst.

In a sixteenth aspect, alone or in combination with one or more of the first through fifteenth aspects, process 1700 includes mapping a resource set to an S-RSB of the one or more S-RSBs of the S-RSB burst based at least in part on a received beam identifier, a beam index, or an S-RSB index indicated in an S-RSB associated with the selected beam.

In a seventeenth aspect, alone or in combination with one or more of the first through sixteenth aspects, process 1700 includes determining a transmitting beam based at least in part on a beam ID, a beam index, an S-RSB index, a TCI state indicated in an S-RSB associated with the selected beam, or a spatial filter indicated by the SCI.

In an eighteenth aspect, alone or in combination with one or more of the first through seventeenth aspects, receiving the one or more S-RSBs in the S-RSB burst includes receiving the one or more S-RSBs using a receiving beam sweep pattern.

In a nineteenth aspect, in combination with the eighteenth aspect alone or in further combination with one or more of the first through seventeenth aspects, the receiving beam sweep pattern includes a beam sweep pattern for beam fine tuning.

In a twentieth aspect, alone or in combination with one or more of the first through nineteenth aspects, receiving the one or more S-RSBs in the S-RSB burst includes receiving the one or more S-RSBs in the S-RSB burst using a receiving beam that is paired to the selected beam as part of a beam-pair link.

In a twenty-first aspect, in combination with one or more of the first through eighteenth aspects, selecting the one or more sidelink resources for the one or more sidelink beam management blocks includes selecting sidelink resources to avoid collisions with other sidelink beam management blocks.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram of an example apparatus 1800 for wireless communication, in accordance with the present disclosure. The apparatus 1800 may be a UE, or a UE may include the apparatus 1800. In some aspects, the apparatus 1800 includes a reception component 1802 and a transmission component 1804, which may be in communication with one another (for example, via one or more buses and/or one or more other components). As shown, the apparatus 1800 may communicate with another apparatus 1806 (such as a UE, a base station, or another wireless communication device) using the reception component 1802 and the transmission component 1804. As further shown, the apparatus 1800 may include the communication manager 1808. The communication manager 1808 may control and/or otherwise manage one or more operations of the reception component 1802 and/or the transmission component 1804. In some aspects, the communication manager 1808 may include one or more antennas, a modem, a controller/processor, a memory, or a combination thereof, of the UE described in connection with FIG. 2. The communication manager 1808 may be, or be similar to, the communication manager 140 depicted in FIGS. 1 and 2. For example, in some aspects, the communication manager 1808 may be configured to perform one or more of the functions described as being performed by the communication manager 140. In some aspects, the communication manager 1808 may include the reception component 1802 and/or the transmission component 1804. The communication manager 1808 may include a sensing component 1810, a selection component 1812, and/or a monitoring component 1814, among other examples.

In some aspects, the apparatus 1800 may be configured to perform one or more operations described herein in connection with FIGS. 1-15B. Additionally, or alternatively, the apparatus 1800 may be configured to perform one or more processes described herein, such as process 1600 of FIG. 16, process 1700 of FIG. 17, or a combination thereof. In some aspects, the apparatus 1800 and/or one or more components shown in FIG. 18 may include one or more components of the UE described in connection with FIG. 2. Additionally, or alternatively, one or more components shown in FIG. 18 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1802 may receive communications, such as reference signals, control information, data communications, or a combination thereof, from the apparatus 1806. The reception component 1802 may provide received communications to one or more other components of the apparatus 1800. In some aspects, the reception component 1802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1800. In some aspects, the reception component 1802 may include one or more antennas, a modem, a demodulator, a MIMO detector, a receive processor, a controller/processor, a memory, or a combination thereof, of the UE described in connection with FIG. 2.

The transmission component 1804 may transmit communications, such as reference signals, control information, data communications, or a combination thereof, to the apparatus 1806. In some aspects, one or more other components of the apparatus 1800 may generate communications and may provide the generated communications to the transmission component 1804 for transmission to the apparatus 1806. In some aspects, the transmission component 1804 may perform signal processing on the generated communications (such as filtering, amplification, modulation, digital-to-analog conversion, multiplexing, interleaving, mapping, or encoding, among other examples), and may transmit the processed signals to the apparatus 1806. In some aspects, the transmission component 1804 may include one or more antennas, a modem, a modulator, a transmit MIMO processor, a transmit processor, a controller/processor, a memory, or a combination thereof, of the UE described in connection with FIG. 2. In some aspects, the transmission component 1804 may be co-located with the reception component 1802 in a transceiver.

In some aspects, the sensing component 1810 may perform sensing in a sidelink resource pool. The selection component 1812 may select, based at least in part on the sensing, one or more sidelink resources for one or more sidelink beam management blocks (e.g., S-RSBs), where each S-RSB includes at least one RS and/or SCI. The transmission component 1804 may transmit the one or more S-RSBs in an S-RSB burst using the one or more sidelink resources. The transmission component 1804 may transmit S-RSBs in a second beam sweeping pattern.

The monitoring component 1814 may monitor for a sidelink communication based at least in part on each S-RSB of the one or more S-RSBs in the S-RSB burst. The reception component 1802 may receive the sidelink communication. The reception component 1802 may receive an indication of a selected beam associated with the second beam sweeping pattern.

In some aspects, the monitoring component 1814 may monitor for one or more sidelink beam management blocks in a sidelink beam management block burst (e.g., S-RSBs in an S-RSB burst) in a sidelink resource pool. The reception component 1802 may receive the one or more S-RSBs in the S-RSB burst, where each S-RSB in the S-RSB burst includes at least one RS and/or SCI. The selection component 1812 may select a beam based at least in part on the one or more S-RSBs in the S-RSB burst.

The sensing component 1810 may perform sensing for a sidelink communication. The selection component 1812 may select a resource for the sidelink communication based at least in part on the selected beam. The transmission component 1804 may transmit the sidelink communication.

The selection component 1812 may map a resource set to an S-RSB of the one or more S-RSBs of the S-RSB burst based at least in part on a received beam identifier, a beam index, or an S-RSB index indicated in an S-RSB associated with the selected beam. The selection component 1812 may determine a transmitting beam based at least in part on a beam identifier, a beam index, an S-RSB index, a TCI state indicated in an S-RSB associated with the selected beam, or a spatial filter indicated by the SCI.

The number and arrangement of components shown in FIG. 18 are provided as an example. In practice, there may be additional components, fewer components, different components, or differently arranged components than those shown in FIG. 18. Furthermore, two or more components shown in FIG. 18 may be implemented within a single component, or a single component shown in FIG. 18 may be implemented as multiple, distributed components. Additionally, or alternatively, a set of (one or more) components shown in FIG. 18 may perform one or more functions described as being performed by another set of components shown in FIG. 18.

The following provides an overview of some Aspects of the present disclosure:
Aspect 1: A method of wireless communication performed by an apparatus of a user equipment (UE), comprising: performing sensing in a sidelink resource pool; selecting, based at least in part on the sensing, one or more sidelink resources for one or more sidelink reference signal blocks (S-RSBs), wherein each S-RSB includes at least one reference signal (RS) and sidelink control information (SCI); and transmitting the one or more S-RSBs in an S-RSB burst using the one or more sidelink resources.
Aspect 2: The method of Aspect 1, wherein the sidelink resource pool is a resource pool for sidelink beam management.
Aspect 3: The method of Aspect 1 or 2, wherein the S-RSB burst one or more of includes a quantity of S-RSBs within the S-RSB burst, has a specified duration, uses a time period for transmission of the S-RSB burst, or uses an offset for starting the S-RSB burst.
Aspect 4: The method of Aspect 3, wherein the SCI indicates a time interval for resource reservation based at least in part on a time period for transmission of the S-RSB burst.
Aspect 5: The method of any of Aspects 1-4, wherein the SCI indicates one or more time and frequency resources reserved for one or more S-RSB transmissions respectively in one or more S-RSB bursts.
Aspect 6: The method of any of Aspects 1-5, wherein the SCI indicates an S-RSB index of the S-RSB within the S-RSB burst.
Aspect 7: The method of any of Aspects 1-6, wherein the SCI indicates a transmission configuration indicator (TCI) state or a spatial filter of a beam used to transmit the S-RSB.
Aspect 8: The method of any of Aspects 1-7, wherein the SCI indicates an identifier or an index of a beam used to transmit the S-RSB.
Aspect 9: The method of any of Aspects 1-8, wherein the SCI includes a source identifier.
Aspect 10: The method of any of Aspects 1-9, wherein the SCI indicates a beam management operation, wherein the beam management operation includes beamforming, beam fine tuning, or beam measurement.
Aspect 11: The method of any of Aspects 1-10, wherein the SCI is an SCI part 1, and wherein the S-RSB includes SCI part 2 that indicates one or more of a source identifier (ID) or a destination ID.
Aspect 12: The method of any of Aspects 1-11, wherein the SCI is an SCI part 1, and wherein the S-RSB includes SCI part 2 that indicates preferred resources or non-preferred resources associated with the S-RSB.
Aspect 13: The method of any of Aspects 1-12, wherein the at least one RS includes a first RS used for automatic gain control.
Aspect 14: The method of any of Aspects 1-13, wherein the at least one RS includes a second RS for beamforming, beam fine tuning, or beam measurements.
Aspect 15: The method of any of Aspects 1-14, further comprising: monitoring for a sidelink communication based at least in part on each S-RSB of the one or more S-RSBs in the S-RSB burst; and receiving the sidelink communication.
Aspect 16: The method of Aspect 15, wherein monitoring for the sidelink communication includes monitoring for the sidelink communication in one or more resource sets based at least in part on one or more of: a configured time duration after each S-RSB of the one or more S-RSBs in the S-RSB burst, a mapping of each resource set of the one or more resource sets with a respective S-RSB of the one or more S-RSBs in the S-RSB burst, or SCI part 2 included in each S-RSB of the one or more S-RSBs in the S-RSB burst.
Aspect 17: The method of Aspect 15 or 16, wherein monitoring for the sidelink communication includes monitoring for the sidelink communication using one or more receiving beams that are based at least in part on one or more respective transmitting beams that are associated with each S-RSB of the one or more S-RSBs in the S-RSB burst.
Aspect 18: The method of any of Aspects 15-17, wherein the sidelink communication includes a discovery message, a direct communication request (DCR), or a beam report.
Aspect 19: The method of any of Aspects 1-18, wherein transmitting the one or more S-RSBs in the S-RSB burst includes transmitting the one or more S-RSBs in a first beam sweeping pattern.
Aspect 20: The method of Aspect 19, further comprising transmitting S-RSBs in a second beam sweeping pattern.
Aspect 21: The method of Aspect 20, further comprising receiving an indication of a selected beam associated with the second beam sweeping pattern.
Aspect 22: The method of Aspect 20 or 21, wherein the first beam sweeping pattern is for beamforming, and wherein an S-RSB of the first beam sweeping pattern is mapped to the second beam sweeping pattern for beam fine tuning.
Aspect 23: The method of any of Aspects 1-22, wherein transmitting the one or more S-RSBs in the S-RSB burst includes transmitting repetitions of an S-RSB.
Aspect 24: A method of wireless communication performed by an apparatus of a user equipment (UE), comprising: monitoring for one or more sidelink reference signal blocks (S-RSBs) in an S-RSB burst in a sidelink resource pool; receiving the one or more S-RSBs in the S-RSB burst, wherein each S-RSB in the S-RSB burst includes at least one reference signal (RS) and sidelink control information (SCI); and selecting a beam based at least in part on the one or more S-RSBs in the S-RSB burst.
Aspect 25: The method of Aspect 24, further comprising: performing sensing for a sidelink communication; selecting a resource for the sidelink communication based at least in part on the selected beam; and transmitting the sidelink communication.
Aspect 26: The method of Aspect 25, wherein selecting the resource includes selecting the resource from a resource set based at least in part one or more of: a configured time duration after each S-RSB of the one or more S-RSBs in the S-RSB burst, a mapping of the resource set with an S-RSB of the one or more S-RSBs in the S-RSB burst, or SCI part 2 included in each S-RSB of the one or more S-RSBs in the S-RSB burst.
Aspect 27: The method of Aspect 25 or 26, wherein transmitting the sidelink communication includes transmitting the sidelink communication using a transmitting beam that is associated with the selected beam.
Aspect 28: The method of any of Aspects 25-27, wherein the sidelink communication includes a discovery message, a direct communication request (DCR), or a beam report.
Aspect 29: The method of any of Aspects 24-28, wherein the SCI indicates one or more time and frequency resources reserved for one or more S-RSB transmissions respectively in one or more S-RSB bursts.
Aspect 30: The method of any of Aspects 24-29, wherein the SCI indicates an S-RSB index of the S-RSB within the S-RSB burst.
Aspect 31: The method of any of Aspects 24-30, wherein the SCI indicates a transmission configuration indicator (TCI) state or a spatial filter of a beam used to transmit the S-RSB.
Aspect 32: The method of any of Aspects 24-31, wherein the SCI indicates an identifier or an index of a beam used to transmit the S-RSB.
Aspect 33: The method of any of Aspects 24-32, wherein the SCI includes a source identifier.
Aspect 34: The method of any of Aspects 24-33, wherein the SCI indicates a beam management operation, and wherein selecting the beam includes selecting the beam based at least in part on the beam management operation.
Aspect 35: The method of any of Aspects 24-34, wherein the SCI is an SCI part 1, and wherein the S-RSB includes SCI part 2 that indicates one or more of a source identifier (ID) or a destination ID.
Aspect 36: The method of any of Aspects 24-35, wherein the SCI is an SCI part 1, and wherein the S-RSB includes SCI part 2 that indicates preferred resources or non-preferred resources associated with the S-RSB.
Aspect 37: The method of any of Aspects 24-36, wherein the at least one RS includes a first RS used for automatic gain control.
Aspect 38: The method of Aspect 37, wherein the at least one RS includes a second RS for beam forming, fine tuning, or beam measurements.
Aspect 39: The method of any of Aspects 24-38, wherein selecting the beam includes selecting the beam based at least in part on measurements of the one or more S-RSBs in the S-RSB burst.
Aspect 40: The method of any of Aspects 24-39, further comprising mapping a resource set to an S-RSB of the one or more S-RSBs of the S-RSB burst based at least in part on a received beam identifier, a beam index, or an S-RSB index indicated in an S-RSB associated with the selected beam.
Aspect 41: The method of any of Aspects 24-40, further comprising determining a transmitting beam based at least in part on a beam identifier, a beam index, an S-RSB index, a transmission configuration indicator (TCI) state indicated in an S-RSB associated with the selected beam, or a spatial filter indicated by the SCI.
Aspect 42: The method of any of Aspects 24-41, wherein receiving the one or more S-RSBs in the S-RSB burst includes receiving the one or more S-RSBs using a receiving beam sweep pattern.
Aspect 43: The method of Aspect 42, wherein the receiving beam sweep pattern includes a beam sweep pattern for beam fine tuning.
Aspect 44: The method of any of Aspects 24-43, wherein receiving the one or more S-RSBs in the S-RSB burst includes receiving the one or more S-RSBs in the S-RSB burst using a receiving beam that is paired to the selected beam as part of a beam-pair link.
Aspect 45: An apparatus for wireless communication at a device, comprising a processor; memory coupled with the processor; and instructions stored in the memory and executable by the processor to cause the apparatus to perform the method of one or more of Aspects 1-44.
Aspect 46: A device for wireless communication, comprising a memory and one or more processors coupled to the memory, the one or more processors configured to perform the method of one or more of Aspects 1-44.
Aspect 47: An apparatus for wireless communication, comprising at least one means for performing the method of one or more of Aspects 1-44.
Aspect 48: A non-transitory computer-readable medium storing code for wireless communication, the code comprising instructions executable by a processor to perform the method of one or more of Aspects 1-44.
Aspect 49: A non-transitory computer-readable medium storing a set of instructions for wireless communication, the set of instructions comprising one or more instructions that, when executed by one or more processors of a device, cause the device to perform the method of one or more of Aspects 1-44.
Aspect 50: A method of wireless communication performed by a user equipment (UE), comprising: performing sensing in a sidelink resource pool; selecting, based at least in part on the sensing, one or more sidelink resources for one or more sidelink beam management blocks, wherein each sidelink beam management block includes at least one beam management signal and sidelink control information (SCI); and transmitting the one or more sidelink beam management blocks in a sidelink beam management block burst using the one or more sidelink resources.
Aspect 51: The method of Aspect 50, wherein the sidelink resource pool is a resource pool for sidelink beam management.
Aspect 52: The method of any of Aspects 50-51, wherein the sidelink beam management block burst one or more of includes a quantity of sidelink beam management blocks within the sidelink beam management block burst, has a specified duration, uses a time period for transmission of the sidelink beam management block burst, or uses an offset for starting the sidelink beam management block burst.
Aspect 53: The method of Aspect 52, wherein the SCI indicates a time interval for resource reservation based at least in part on a time period for transmission of the sidelink beam management block burst.
Aspect 54: The method of any of Aspects 50-53, wherein the SCI indicates one or more time and frequency resources reserved for one or more sidelink beam management block transmissions respectively in one or more sidelink beam management block bursts.
Aspect 55: The method of any of Aspects 50-54, wherein the SCI indicates a sidelink beam management block index of a sidelink beam management block within the sidelink beam management block burst.
Aspect 56: The method of any of Aspects 50-55, wherein the SCI indicates a transmission configuration indicator (TCI) state or a spatial filter of a beam used to transmit the sidelink beam management block.
Aspect 57: The method of any of Aspects 50-56, wherein the SCI indicates an identifier or an index of a beam used to transmit the sidelink beam management block.
Aspect 58: The method of any of Aspects 50-57, wherein the SCI includes a source identifier.
Aspect 59: The method of any of Aspects 50-58, wherein the SCI indicates a beam management operation, wherein the beam management operation includes beamforming, beam fine tuning, or beam measurement.
Aspect 60: The method of any of Aspects 50-59, wherein the SCI is an SCI part 1, and wherein the sidelink beam management block includes SCI part 2 that indicates one or more of a source identifier (ID) or a destination ID.
Aspect 61: The method of any of Aspects 50-60, wherein the SCI is an SCI part 1, and wherein the sidelink beam management block includes SCI part 2 that indicates preferred resources or non-preferred resources associated with the sidelink beam management block.
Aspect 62: The method of any of Aspects 50-61, wherein the at least one beam management signal includes a first reference signal used for automatic gain control.
Aspect 63: The method of any of Aspects 50-62, wherein the at least one beam management signal includes a reference signal, a synchronization signal, a sequence for a synchronization signal, or a sequence for a reference signal.
Aspect 64: The method of any of Aspects 50-63, wherein the at least one beam management signal includes a second beam management signal for beamforming, beam fine tuning, or beam measurements.
Aspect 65: The method of any of Aspects 50-64, further comprising: monitoring for a sidelink communication based at least in part on each sidelink beam management block of the one or more sidelink beam management blocks in the sidelink beam management block burst; and receiving the sidelink communication.
Aspect 66: The method of Aspect 65, wherein monitoring for the sidelink communication includes monitoring for the sidelink communication in one or more resource sets based at least in part on one or more of: a configured time duration after each sidelink beam management block of the one or more sidelink beam management blocks in the sidelink beam management block burst, a mapping of each resource set of the one or more resource sets with a respective sidelink beam management block of the one or more sidelink beam management blocks in the sidelink beam management block burst, or SCI part 2 included in each sidelink beam management block of the one or more sidelink beam management blocks in the sidelink beam management block burst.
Aspect 67: The method of Aspect 65, wherein monitoring for the sidelink communication includes monitoring for the sidelink communication using one or more receiving beams that are based at least in part on one or more respective transmitting beams that are associated with each sidelink beam management block of the one or more sidelink beam management blocks in the sidelink beam management block burst.
Aspect 68: The method of Aspect 65, wherein the sidelink communication includes a discovery message, a direct communication request (DCR), or a beam report.
Aspect 69: The method of any of Aspects 50-68, wherein transmitting the one or more sidelink beam management blocks in the sidelink beam management block burst comprises transmitting the one or more sidelink beam management blocks in a first beam sweeping pattern.
Aspect 70: The method of Aspect 69, further comprising transmitting sidelink beam management blocks in a second beam sweeping pattern.
Aspect 71: The method of Aspect 70, further comprising receiving an indication of a selected beam associated with the second beam sweeping pattern.
Aspect 72: The method of Aspect 69, wherein the first beam sweeping pattern is for beamforming, and wherein a sidelink beam management block of the first beam sweeping pattern is mapped to a second beam sweeping pattern for beam fine tuning.
Aspect 73: The method of any of Aspects 50-72, wherein transmitting the one or more sidelink beam management blocks in the sidelink beam management block burst includes transmitting repetitions of a sidelink beam management block.
Aspect 74: The method of any of Aspects 50-73, wherein selecting the one or more sidelink resources for the one or more sidelink beam management blocks includes selecting sidelink resources to avoid collisions with other sidelink beam management blocks.
Aspect 75: A method of wireless communication performed by a user equipment (UE), comprising: monitoring for one or more sidelink beam management blocks in a sidelink beam management block burst in a sidelink resource pool; receiving the one or more sidelink beam management blocks in the sidelink beam management block burst, wherein each sidelink beam management block in the sidelink beam management block burst includes at least one beam management signal and sidelink control information (SCI); and selecting a beam based at least in part on the one or more sidelink beam management blocks in the sidelink beam management block burst.
Aspect 76: The method of Aspect 75, further comprising: performing sensing for a sidelink communication; selecting a resource for the sidelink communication based at least in part on the selected beam; and transmitting the sidelink communication.
Aspect 77: The method of Aspect 76, wherein selecting the resource includes selecting the resource from a resource set based at least in part one or more of: a configured time duration after each sidelink beam management block of the one or more sidelink beam management blocks in the sidelink beam management block burst, a mapping of the resource set with a sidelink beam management block of the one or more sidelink beam management blocks in the sidelink beam management block burst, or SCI part 2 included in each sidelink beam management block of the one or more sidelink beam management blocks in the sidelink beam management block burst.
Aspect 78: The method of Aspect 76, wherein transmitting the sidelink communication includes transmitting the sidelink communication using a transmitting beam that is associated with the selected beam.
Aspect 79: The method of Aspect 76, wherein the sidelink communication includes a discovery message, a direct communication request (DCR), or a beam report.
Aspect 80: The method of any of Aspects 75-79, wherein the SCI indicates one or more time and frequency resources reserved for one or more sidelink beam management block transmissions respectively in one or more sidelink beam management block bursts.
Aspect 81: The method of any of Aspects 75-80, wherein the SCI indicates a sidelink beam management block index of the sidelink beam management block within the sidelink beam management block burst.
Aspect 82: The method of any of Aspects 75-81, wherein the SCI indicates a transmission configuration indicator (TCI) state or a spatial filter of a beam used to transmit the sidelink beam management block.
Aspect 83: The method of any of Aspects 75-82, wherein the SCI indicates an identifier or an index of a beam used to transmit the sidelink beam management block.
Aspect 84: The method of any of Aspects 75-83, wherein the SCI includes a source identifier.
Aspect 85: The method of any of Aspects 75-84, wherein selecting the beam comprises selecting the beam based at least in part on the beam management operation.
Aspect 86: The method of any of Aspects 75-85, wherein the SCI is an SCI part 1, and wherein the sidelink beam management block includes SCI part 2 that indicates one or more of a source identifier (ID) or a destination ID.
Aspect 87: The method of any of Aspects 75-86, wherein the SCI is an SCI part 1, and wherein the sidelink beam management block includes SCI part 2 that indicates preferred resources or non-preferred resources associated with the sidelink beam management block.
Aspect 88: The method of any of Aspects 75-87, wherein the at least one beam management signal includes a first beam management signal used for automatic gain control.
Aspect 89: The method of Aspect 88, wherein the at least one beam management signal includes a second beam management signal for beam forming, fine tuning, or beam measurements.
Aspect 90: The method of any of Aspects 75-89, wherein selecting the beam includes selecting the beam based at least in part on measurements of the one or more sidelink beam management blocks in the sidelink beam management block burst.
Aspect 91: The method of any of Aspects 75-90, further comprising mapping a resource set to a sidelink beam management block of the one or more sidelink beam management blocks of the sidelink beam management block burst based at least in part on a received beam identifier, a beam index, or an sidelink beam management block index indicated by SCI in a sidelink beam management block associated with the selected beam.
Aspect 92: The method of any of Aspects 75-91, further comprising determining a transmitting beam based at least in part on a beam identifier, a beam index, a sidelink beam management block index, a transmission configuration indicator (TCI) state indicated by SCI in a sidelink beam management block associated with the selected beam, or a spatial filter indicated by the SCI.
Aspect 93: The method of any of Aspects 75-92, wherein receiving the one or more sidelink beam management blocks in the sidelink beam management block burst includes receiving the one or more sidelink beam management blocks using a receiving beam sweep pattern.
Aspect 94: The method of Aspect 93, wherein the receiving beam sweep pattern includes a beam sweep pattern for beam fine tuning.
Aspect 95: The method of any of Aspects 75-94, wherein receiving the one or more sidelink beam management blocks in the sidelink beam management block burst includes receiving the one or more S-RSBs in the sidelink beam management block burst using a receiving beam that is paired to the selected beam as part of a beam-pair link.
Aspect 96: An apparatus for wireless communication at a device, comprising a processor; memory coupled with the processor; and instructions stored in the memory and executable by the processor to cause the apparatus to perform the method of one or more of Aspects 50-95.
Aspect 97: A device for wireless communication, comprising a memory and one or more processors coupled to the memory, the one or more processors configured to perform the method of one or more of Aspects 50-95.
Aspect 98: An apparatus for wireless communication, comprising at least one means for performing the method of one or more of Aspects 50-95.
Aspect 99: A non-transitory computer-readable medium storing code for wireless communication, the code comprising instructions executable by a processor to perform the method of one or more of Aspects 50-95.
Aspect 100: A non-transitory computer-readable medium storing a set of instructions for wireless communication, the set of instructions comprising one or more instructions that, when executed by one or more processors of a device, cause the device to perform the method of one or more of Aspects 50-95.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus of a user equipment (UE) for wireless communication, comprising:
a memory; and
one or more processors, coupled to the memory, configured to cause the UE to:
perform sensing in a sidelink resource pool;
select, based at least in part on the sensing, one or more sidelink resources for one or more sidelink beam management blocks, wherein each sidelink beam management block includes at least one beam management signal and sidelink control information (SCI); and
transmit the one or more sidelink beam management blocks in a sidelink beam management block burst using the one or more sidelink resources.

2. The apparatus of claim 1, wherein the sidelink resource pool is a resource pool for sidelink beam management.

3. The apparatus of claim 1, wherein the sidelink beam management block burst one or more of:
includes a quantity of sidelink beam management blocks within the sidelink beam management block burst,
has a specified duration,
uses a time period for transmission of the sidelink beam management block burst,
or uses an offset for starting the sidelink beam management block burst.

4. The apparatus of claim 3, wherein the SCI indicates a time interval for resource reservation based at least in part on a time period for transmission of the sidelink beam management block burst.

5. The apparatus of claim 1, wherein the SCI indicates one or more time and frequency resources reserved for one or more sidelink beam management block transmissions respectively in one or more sidelink beam management block bursts.

6. The apparatus of claim 1, wherein the SCI indicates a sidelink beam management block index of a sidelink beam management block within the sidelink beam management block burst.

7. The apparatus of claim 1, wherein the SCI indicates a transmission configuration indicator (TCI) state or a spatial filter of a beam used to transmit the sidelink beam management block.

8. The apparatus of claim 1, wherein the SCI indicates an identifier or an index of a beam used to transmit the sidelink beam management block.

9. The apparatus of claim 1, wherein the SCI includes a source identifier.

10. The apparatus of claim 1, wherein the SCI is an SCI part 1, and wherein the sidelink beam management block includes SCI part 2 that indicates one or more of a source identifier (ID) or a destination ID.

11. The apparatus of claim 1, wherein the at least one beam management signal includes a first beam management signal used for automatic gain control.

12. The apparatus of claim 1, wherein the at least one beam management signal includes a reference signal, a synchronization signal, a sequence for a synchronization signal, or a sequence for a reference signal.

13. The apparatus of claim 1, wherein the at least one beam management signal includes a second beam management signal for beamforming, beam fine tuning, or beam measurements.

14. The apparatus of claim 1, wherein the one or more processors are configured to:
monitor for a sidelink communication based at least in part on each sidelink beam management block of the one or more sidelink beam management blocks in the sidelink beam management block burst; and
receive the sidelink communication.

15. The apparatus of claim 14, wherein the one or more processors, to monitor for the sidelink communication, are configured to monitor for the sidelink communication in one or more resource sets based at least in part on one or more of:
a configured time duration after each sidelink beam management block of the one or more sidelink beam management blocks in the sidelink beam management block burst,
a mapping of each resource set of the one or more resource sets with a respective sidelink beam management block of the one or more sidelink beam management blocks in the sidelink beam management block burst, or
SCI part 2 included in each sidelink beam management block of the one or more sidelink beam management blocks in the sidelink beam management block burst.

16. The apparatus of claim 14, wherein the one or more processors, to monitor for the sidelink communication, are configured to monitor for the sidelink communication using one or more receiving beams that are based at least in part on one or more respective transmitting beams that are associated with each sidelink beam management block of the one or more sidelink beam management blocks in the sidelink beam management block burst.

17. The apparatus of claim 14, wherein the sidelink communication includes a discovery message, a direct communication request (DCR), or a beam report.

18. The apparatus of claim 1, wherein the one or more processors, to transmit the one or more sidelink beam management blocks in the sidelink beam management block burst, are configured to transmit repetitions of a sidelink beam management block.

19. The apparatus of claim 1, wherein the one or more processors, to select the one or more sidelink resources for the one or more sidelink beam management blocks, are configured to select sidelink resources to avoid collisions with other sidelink beam management blocks.

20. An apparatus of a user equipment (UE) for wireless communication, comprising:
a memory; and
one or more processors, coupled to the memory, configured to cause the UE to:
monitor for one or more sidelink beam management blocks in a sidelink beam management block burst in a sidelink resource pool;
receive the one or more sidelink beam management blocks in the sidelink beam management block burst, wherein each sidelink beam management block in the sidelink beam management block burst includes at least one beam management signal and sidelink control information (SCI); and
select a beam based at least in part on the one or more sidelink beam management blocks in the sidelink beam management block burst.

21. The apparatus of claim 20, wherein the one or more processors are configured to:
perform sensing for a sidelink communication;
select a resource for the sidelink communication based at least in part on the selected beam; and
transmit the sidelink communication.

22. The apparatus of claim 21, wherein the one or more processors, to select the resource, are configured to select the resource from a resource set based at least in part one or more of:
a configured time duration after each sidelink beam management block of the one or more sidelink beam management blocks in the sidelink beam management block burst,
a mapping of the resource set with a sidelink beam management block of the one or more sidelink beam management blocks in the sidelink beam management block burst, or
SCI part 2 included in each sidelink beam management block of the one or more sidelink beam management blocks in the sidelink beam management block burst.

23. The apparatus of claim 21, wherein the one or more processors, to transmit the sidelink communication, are configured to transmit the sidelink communication using a transmitting beam that is associated with the selected beam.

24. The apparatus of claim 21, wherein the sidelink communication includes a discovery message, a direct communication request (DCR), or a beam report.

25. The apparatus of claim 20, wherein the SCI indicates one or more time and frequency resources reserved for one or more sidelink beam management block transmissions respectively in one or more sidelink beam management block bursts.

26. The apparatus of claim 20, wherein the SCI indicates a sidelink beam management block index of the sidelink beam management block within the sidelink beam management block burst.

27. The apparatus of claim 20, wherein the SCI indicates a transmission configuration indicator (TCI) state or a spatial filter of a beam used to transmit the sidelink beam management block.

28. The apparatus of claim 20, wherein the SCI indicates an identifier or an index of a beam used to transmit the sidelink beam management block.

29. The apparatus of claim 20, wherein the SCI includes a source identifier.

30. The apparatus of claim 20, wherein the SCI is an SCI part 1, and wherein the sidelink beam management block includes SCI part 2 that indicates one or more of a source identifier (ID) or a destination ID.

31. The apparatus of claim 20, wherein the at least one beam management signal includes a first beam management signal used for automatic gain control.

32. The apparatus of claim 31, wherein the at least one beam management signal includes a second beam management signal for beam forming, fine tuning, or beam measurements.

33. The apparatus of claim 20, wherein the one or more processors, to select the beam, are configured to select the beam based at least in part on measurements of the one or more sidelink beam management blocks in the sidelink beam management block burst.

34. The apparatus of claim 20, wherein the one or more processors are configured to map a resource set to a sidelink beam management block of the one or more sidelink beam management blocks of the sidelink beam management block burst based at least in part on a received beam identifier, a beam index, or an sidelink beam management block index indicated by SCI in a sidelink beam management block associated with the selected beam.

35. The apparatus of claim 20, wherein the one or more processors are configured to determine a transmitting beam based at least in part on a beam identifier, a beam index, a sidelink beam management block index, a transmission configuration indicator (TCI) state indicated by SCI in a sidelink beam management block associated with the selected beam, or a spatial filter indicated by the SCI.

36. The apparatus of claim 20, wherein the one or more processors, to receive the one or more sidelink beam management blocks in the sidelink beam management block burst, are configured to receive the one or more sidelink beam management blocks in the sidelink beam management block burst using a receiving beam that is paired to the selected beam as part of a beam-pair link.

37. A method of wireless communication performed by an apparatus of a user equipment (UE), comprising:
performing sensing in a sidelink resource pool;
selecting, based at least in part on the sensing, one or more sidelink resources for one or more sidelink beam management blocks, wherein each beam management block includes at least one beam management signal and sidelink control information (SCI); and
transmitting the one or more beam management blocks in a beam management burst using the one or more sidelink resources.

38. A method of wireless communication performed by an apparatus of a user equipment (UE), comprising:
monitoring for one or more sidelink beam management blocks in a beam management block burst in a sidelink resource pool;
receiving the one or more beam management blocks in the beam management block burst, wherein each S-RSB in the beam management block burst includes at least one beam management signal and sidelink control information (SCI); and
selecting a beam based at least in part on the one or more S-RSBs in the beam management block burst.
